(19) United States
(12) Patent Application Publication
(10) Pub. No.: US 2025/0069095 A1
(43) Pub. Date: Feb. 27, 2025

(54) SYSTEMS AND METHODS FOR PRODUCT AUTHENTICATION

(71) Applicant: XenTag Corporation, Mississauga (CA)

(72) Inventors: Puneet Pal Singh Randhawa, Mississauga (CA); Vishal Kumar Singh, Mississauga (CA)

(21) Appl. No.: 18/647,073

(22) Filed: Apr. 26, 2024

Related U.S. Application Data
(60) Provisional application No. 63/534,238, filed on Aug. 23, 2023.

(51) Int. Cl. G06Q 30/018

(52) U.S. Cl. CPC G06Q 30/0185

(57) ABSTRACT

Various embodiments for authenticating a product associated with a batch production are disclosed. Embodiments disclosed involve scanning a tag affixed on the product and operating a processor to retrieve product identification information which includes an encrypted first chain identifier. The processor then identifies a smart contract for authenticating the product, retrieves from a genesis record stored on the blockchain a batch creation time for the product, and transmits to the smart contract, information to decrypt the smart contract to obtain a second decryption key fragment. The processor then decrypts the first chain identifier using the first decryption key fragment and the second decryption key fragment and determines whether the product is authentic based on a comparison of the batch creation times included in the first chain identifier and the genesis record. Various embodiments for generating tag information for tags affixable to products associated with a batch production are also disclosed.

### CROSS-REFERENCE TO RELATED APPLICATIONS

This application claims the benefit of U.S. provisional Application No. 63/534,238 filed on Aug. 23, 2023, the entirety of which is herein incorporated by reference.

### FIELD

The embodiments described herein generally relate to systems and methods for generating tag information and authenticating products.

### BACKGROUND

The following is not an admission that anything discussed below is part of the prior art or part of the common general knowledge of a person skilled in the art.

High value products and unique products are often susceptible to being imitated, counterfeited or forged. In many cases, it can be difficult to determine the authenticity of such products from a visual inspection alone. To identify authentic products, manufacturers of these products often associate products with unique serial codes printed on the product or on a label or tag affixed to the product that can be verified against a registry. These serial codes however can be copied by unscrupulous third parties having access to an authentic serial code.

To remedy this problem, encoded labels and tags that allow a user to verify the authenticity of a product by scanning a label or tag have been developed. However, existing approaches to encoding tags and authenticating products are often susceptible to attacks. For example, information obtained from encoded tags and labels can be used to create duplicate tags that can be then affixed to inauthentic products.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In a first aspect, in at least one embodiment, there is provided a method for method for generating tag information for a plurality of tags affixable to a plurality of products, the plurality of products being associated with a batch production in a manufacturing process, the batch production yielding a predetermined number of products corresponding to a same product type. The method comprises: receiving, at a tag creation system, from a manufacturing system associated with a manufacturer operating the batch production, information related to the batch production; generating, by a processor of the tag creation system, a first cryptographic key pair and a second cryptographic key pair associated with the predetermined number of products corresponding to the batch production; generating, by the processor of the tag creation system, for each of the plurality of tags, a corresponding record, each record comprising at least a portion of the information related to the batch production; and transmitting to an encoding system, an encryption key of the first cryptographic key pair, an encryption key of the second cryptographic key pair and instructions for encoding each record on the corresponding tag. The instructions comprise: instructions for encrypting a unique first encryptable information in a first portion of a corresponding record using the encryption key of the first cryptographic key pair; and instructions for encrypting a unique second encryptable information in a second portion of the corresponding record using the encryption key of the second cryptographic key pair.

In some embodiments, the information related to the batch production comprises one or more of a batch identifier corresponding to the batch production in the manufacturing process, a product identifier corresponding to the predetermined number of products in the batch production, a batch creation time corresponding to a time of completion of the batch production and a product count corresponding to the predetermined number of products yielded in the batch production.

In some embodiments, for each record, the first encryptable information comprises a tag identifier of the corresponding tag.

In some embodiments, the tag identifier is a universally unique identifier (UUID).

In some embodiments, the method further involves storing the information related to the batch production in a database.

In some embodiments, for each record, the second encryptable information comprises a chain identifier, wherein the chain identifier comprises a batch creation time corresponding to a time of completion of the batch production, the tag identifier identifying the corresponding tag and a serial number for the corresponding tag.

In some embodiments, the method further comprises generating a genesis record for the batch production comprising the information related to the batch production; and storing the genesis record on a block in a blockchain.

In some embodiments, generating the genesis record comprises initiating a transaction between a first blockchain wallet and a second blockchain wallet, the first blockchain wallet and the second blockchain wallet associated with the tag creation system.

In some embodiments, the method further comprises upon completion of encryption of the second encryptable information on the plurality of records corresponding to the plurality of tags, discarding the encryption key of the second cryptographic key pair.

In some embodiments, each of the plurality of tags is one of an NFC tag or an RFID tag.

In some embodiments, the method further comprises receiving, from a user device, a claim of ownership signal for a product of the plurality of products; and in response to receiving the claim of ownership signal, generating a token representative of the product in the blockchain.

In some embodiments, the token includes a pointer to one or more of the genesis record and a smart contract associated with the batch production.

In some embodiments, the method further comprises generating, in response to a first claim of ownership corresponding to the batch production, the smart contract associated with the batch production.

In some embodiments, the method further involves fragmenting a decryption key of the second cryptographic key pair into a plurality of fragments; and in response to receiving the claim of ownership, transmitting, to the user device, one fragment of the plurality of fragments.

In some embodiments, the plurality of fragments corresponds to the predetermined number of products.

In some embodiments, the method further comprises receiving, from a first consumer associated with a first user device, an indication of a transfer of ownership of the token to a second consumer associated with a second user device; and recording the transfer of ownership in a database.

In accordance with another aspect, in at least one embodiment, there is provided a system for generating tag information for a plurality of tags affixable to a plurality of products, the plurality of products being associated with a batch production in a manufacturing processor, the batch production yielding a predetermined number of products corresponding to a same product type. The system comprises a manufacturing system associated with a manufacturer operating the batch production. The manufacturing system comprises a processor configured to generate information related to the batch production and transmit the information related to the batch production. The system also comprises a tag creation system comprising at least one processor configured to: receive, from the manufacturing system, information related to the batch production; generate a first cryptographic key pair and a second cryptographic key pair associated with the predetermined number of products corresponding to the batch production; generate, for each of the plurality of tags, a corresponding record, each record comprising at least a portion of the information related to the batch pro-duction; and transmit an encryption key of the first cryptographic key pair, an encryption key of the second cryptographic key pair and instructions for encoding each record on the corresponding tag. The instructions comprise instructions for encrypting a unique first encryptable information in a first portion of a corresponding record using the encryption key of the first cryptographic key pair; and instructions for encrypting a unique second encryptable information in a second portion of the corresponding record using the encryption key of the second cryptographic key pair. The system also comprises an encoding system configured to encode each of the plurality of tags according to the instructions received from the tag creation system.

In some embodiments, the information related to the batch production comprises one or more of a batch identifier corresponding to the batch production in the manufacturing process, a product identifier corresponding to the predetermined number of products in the batch production, a batch creation time corresponding to a time of completion of the batch production and a product count corresponding to the predetermined number of products yielded in the batch production.

In some embodiments, for each record, the first encryptable information comprises a tag identifier of the corresponding tag.

In some embodiments, the tag identifier is a universally unique identifier (UUID).

In some embodiments, the tag creation system processor is further configured to store the information related to the batch production in a database.

In some embodiments, for each record, the second encryptable information comprises a chain identifier, wherein the chain identifier comprises a batch creation time corresponding to a time of completion of the batch production, the tag identifier identifying the corresponding tag and a serial number for the corresponding tag.

In some embodiments, the tag creation system processor is further configured to: generate a genesis record for the batch production comprising the information related to the batch production; and store the genesis record on a block in a blockchain.

In some embodiments, generating the genesis record comprises initiating a transaction between a first blockchain wallet and a second blockchain wallet, the first blockchain wallet and the second blockchain wallet associated with the tag creation system.

In some embodiments, the tag creation system processor is configured to: upon completion of encryption of the second encryptable information on the plurality of records corresponding to the plurality of tags, discard the encryption key of the second cryptographic key pair.

In some embodiments, each of the plurality of tags is one of an NFC tag or an RFID tag.

In some embodiments, the tag creation system processor is configured to receive from a user device, a claim of ownership signal for a product of the plurality of products; and in response to receiving the claim of ownership signal, generate a token representative of the product in the blockchain.

In some embodiments, the token includes a pointer to one or more of the genesis record and a smart contract associated with the batch production.

In some embodiments, the tag creation system processor is configured to generate, in response to a first claim of ownership corresponding to the batch production, the smart contract associated with the batch production.

In some embodiments, the tag creation system processor is configured to: fragment a decryption key of the second cryptographic key pair into a plurality of fragments; and in response to receiving the claim of ownership, transmit, to the user device, one fragment of the plurality of fragments.

In some embodiments, the plurality of fragments corresponds to the predetermined number of products.

In some embodiments, the tag creation system processor is further configured to receive, from a first consumer associated with a first user device, an indication of a transfer of ownership of the token to a second consumer associated with a second user device and record the transfer of ownership in a database.

In accordance with another aspect, in at least one embodiment, there is provided a method for authenticating, by an authentication server, one product of a plurality of products associated with a batch production in a manufacturing process, the batch production yielding a predetermined number of products corresponding to a same product type, each product having a corresponding tag affixed thereto. The method comprises: upon scanning a tag affixed to the product, receiving, from a computing device, an address associated with the tag, the address comprising identification information for the product; decrypting a first encrypted portion of the address using a first decryption key stored at the authentication server to obtain a first decrypted information; decrypting, a second encryption portion of the address using a second decryption key stored at the authentication server to obtain a second decrypted information; comparing at least a portion of the first decrypted information and the second decrypted information; and determining an authenticity of the product based on the comparison.

In some embodiments, the identification information for the product comprises one or more of a product identifier corresponding to the predetermined number of products in the batch production, a batch identifier corresponding to the batch production in the manufacturing process and a serial number corresponding to the tag affixed to the product.

In some embodiments, the first decrypted information comprises a tag identifier identifying the tag affixed to the product and a tap count corresponding to scan data of the tag.

In some embodiments, the second decrypted information comprises a chain identifier, wherein the chain identifier comprises the tag identifier identifying the corresponding tag and a serial number for the corresponding tag.

In some embodiments, comparing at least a portion of the first decrypted information and the second decrypted information comprises comparing the tag identifier of the first decrypted information and the tag identifier of the second decrypted information.

In some embodiments, the method further comprises comparing the serial number of the second decrypted information and a serial number comprised in the identification information for the product and determining the authenticity of the product based on the comparison.

In some embodiments, the method further comprises retrieving the second decryption key based on one or more of the product identifier and the batch identifier.

In some embodiments, the first decrypted information comprises a tap count and the method further comprises: comparing the tap count and a previous tap count stored in a database; determining the authenticity of the product based on the tap count comparison; and in response to determining that the product is authentic, storing the tap count in the database.

In some embodiments, the address is a uniform resource locator (URL).

In some embodiments, the method further comprises generating a virtual object associated with the product; and in response to determining the product is authentic, displaying an augmented reality representation of the virtual object on a graphical user interface.

In some embodiments, the virtual object is generated based on the identification information for the product.

In some embodiments, the method further comprises: in response to determining the product is authentic, requesting an image of the product; and in response to receiving the image of the product, displaying the augmented reality representation of the virtual object on the graphical user interface.

In accordance with another aspect, in at least one embodiment, there is provided a system for authenticating one product of a plurality of products associated with a batch production in a manufacturing process, the batch production yielding a predetermined number of products corresponding to a same product type, each product having a corresponding tag affixed thereto. The system comprises a computing device configured to: upon scanning the tag affixed to the product, determine an address associated with the tag, the address comprising identification information for the product; transmit the address to an authentication server. The system also comprises a database storing a first decryption key and a second decryption key; and the authentication server in communication with the computing device and the database. The authentication server comprises at least one processor configured to: decrypt a first encrypted portion of the address using the first decryption key to obtain a first decrypted information; decrypt, a second encryption portion of the address using the second decryption key to obtain a second decrypted information; compare at least a portion of the first decrypted information and the second decrypted information; and determine an authenticity of the product based on the comparison.

In some embodiments, the identification information for the product comprises one or more of a product identifier corresponding to the predetermined number of products in the batch production, a batch identifier corresponding to the batch production in the manufacturing process and a serial number corresponding to the tag affixed to the product.

In some embodiments, the first decrypted information comprises a tag identifier identifying the tag affixed to the product and a tap count corresponding to scan data of the tag.

In some embodiments, the second decrypted information comprises a chain identifier, wherein the chain identifier comprises the tag identifier identifying the corresponding tag and a serial number for the corresponding tag.

In some embodiments, comparing at least a portion of the first decrypted information and the second decrypted information comprises compare the tag identifier of the first decrypted information and the tag identifier of the second decrypted information.

In some embodiments, the at least one processor is configured to compare the serial number of the second decrypted information and the serial number comprised in the identification information for the product and determine the authenticity of the product based on the comparison.

In some embodiments, the at least one processor is configured to retrieve the second decryption key based on one or more of the product identifier and the batch identifier.

In some embodiments, the first decrypted information comprises a tap count and wherein the at least one processor is further configured to: compare the tap count and a previous tap count stored in a database; determine the authenticity of the product based on the tap count comparison; and in response to determining that the product is authentic, store the tap count in the database.

In some embodiments, the address is a uniform resource locator (URL).

In some embodiments, the at least one processor of the authentication server is configured to: generate a virtual object associated with the product; and in response to the authentication server determining the product is authentic, the computing device is configured to display an augmented reality representation of the virtual object on a graphical user interface of the computing device.

In some embodiments, the virtual object is generated based on the identification information for the product.

In some embodiments, the computing device is configured to: request an image of the product; and in response to receiving the image of the product, display the augmented reality representation of the virtual object on the graphical user interface.

In accordance with another aspect, in at least one embodiment, there is provided a blockchain based method for authenticating, by a computing device, one product of a plurality of products associated with a batch production in a manufacturing process, the batch production yielding a predetermined number of products corresponding to a same product type, each product having a corresponding tag affixed thereto. The method comprises: upon scanning the tag affixed to the product, retrieving identification information for the product from an address associated with the tag, the identification information comprising an encrypted first chain identifier; identifying an address on a blockchain for a smart contract for authenticating the product; retrieving, from a genesis record associated with the batch production, stored on the blockchain, a batch creation time for the product; transmitting to the smart contract, a first decryption key fragment, a product key and an offset value to decrypt the smart contract to obtain a second decryption key fragment for the encrypted first chain identifier; decrypting the encrypted first chain identifier using the first decryption key fragment and the second decryption key fragment; and determining an authenticity of the product based on a comparison of a batch creation time included in the decrypted first chain identifier and the batch creation time included in the genesis record.

In some embodiments, the first decryption key fragment is previously received by the computing device at a time of a claim of ownership.

In some embodiments, the product key is previously received by the computing device at a time of a claim of ownership.

In some embodiments, the decrypted first chain identifier comprises a serial number of the product.

In some embodiments, the smart contract comprises a bit array associated with the number of products in the batch production, each bit of the bit array identifying a serial number for a product in the batch production and the method further comprises: determining if the serial number of the product of the decrypted first chain identifier is present in the bit array; and in response to determining that the serial number of the product of the decrypted first chain identifier is not present in the bit array, determining that the product is inauthentic.

In some embodiments, the method further comprises determining the address for the smart contract from a token on the blockchain, the token associated with a consumer associated with the computing device.

In some embodiments, the genesis record is stored on the blockchain and the method further comprises determining an address for the genesis record from the token.

In some embodiments, the token comprises the offset value.

In some embodiments, the smart contract comprises an array and wherein obtaining the second decryption key fragment comprises locating the second decryption key fragment in the array.

In some embodiments, obtaining the second key fragment comprises determining a combined sequence number based on the offset value and the product key and determining a location in the array of the second key fragment based on the combined sequence number.

In some embodiments, the method further comprises determining a serial number for the product based on the combined sequence number and comparing the determined serial number and the serial number of the first chain identifier to determine the authenticity of the product.

In some embodiments, the identification information further comprises a batch identifier and a serial number for the tag.

In some embodiments, the method further comprises generating a virtual object associated with the product; and in response to determining the product is authentic, displaying an augmented reality representation of the virtual object on a graphical user interface.

In some embodiments, the virtual object is generated based on the identification information for the product.

In some embodiments, the method further comprises: in response to determining the product is authentic, requesting an image of the product; and in response to receiving the image of the product, displaying the augmented reality representation of the virtual object on the graphical user interface.

In accordance with another aspect, in at least one embodiment, there is provided a blockchain based system for authenticating one product of a plurality of products associated with a batch production in a manufacturing process, the batch production yielding a predetermined number of products corresponding to a same product type, each product having a corresponding tag affixed thereto. The system comprises a blockchain accessible by a computing device, the blockchain storing a genesis record and a smart contract and the computing device comprising at least one processor configured to: retrieve identification information for the product, from an address associated with a tag affixed to the product, the identification information comprising an encrypted first chain identifier; identify an address on a blockchain, for a smart contract, for authenticating the product; retrieve from a genesis record associated with a batch, a batch creation time for the product; transmit to the smart contract, a first decryption key fragment and a sequence number for the product to decrypt the smart contract to obtain a second decryption key fragment for the encrypted first chain identifier; decrypt the encrypted first chain identifier using the first decryption key fragment and the second decryption key fragment; and determine an authenticity of the product based on a comparison of a batch creation time included in the decrypted first chain identifier and the batch creation time included in the genesis record.

In some embodiments, the first decryption key fragment is previously received by the computing device at a time of a claim of ownership.

In some embodiments, the product key is previously received by the computing device at a time of a claim of ownership.

In some embodiments, the decrypted first chain identifier comprises a serial number for the product.

In some embodiments, the smart contract comprises a bit array associated with the number of products in the batch production, each bit of the bit array identifying a serial number for a product in the batch production and the at least one processor is configured to: determine if the serial number of the product of the decrypted first chain identifier is present in the bit array; and in response to determining that the serial number of the product of the decrypted first chain identifier is not present in the bit array, determine that the product is inauthentic.

In some embodiments, the at least one processor is further configured to determine the address for the smart contract from a token on the blockchain, the token associated with a consumer associated with the computing device.

In some embodiments, the genesis record is stored on the blockchain and the at least one processor is configured to determine an address for the genesis record from the token.

In some embodiments, the token comprises the offset value.

In some embodiments, the smart contract comprises an array and the at least one processor is configured to locate the second decryption key fragment in the array.

In some embodiments, obtaining the second key fragment comprises determining a combined sequence number based on the offset value and the product key and the at least one processor is configured to determine a location in the array of the second key fragment based on the combined sequence number.

In some embodiments, the at least one processor is configured to determine a serial number for the product based on the combined sequence number; compare the determined serial number and the serial number of the decrypted first chain identifier to determine the authenticity of the product.

In some embodiments, the identification information further comprises a batch identifier and a serial number for the tag.

In some embodiments, the at least one processor is configured to: generate a virtual object associated with the product; and in response to the authentication server determining the product is authentic, display an augmented reality representation of the virtual object on a graphical user interface of the computing device.

In some embodiments, the virtual object is generated based on the identification information for the product.

In some embodiments, the at least one processor is configured to: request an image of the product; and in response to receiving the image of the product, display the augmented reality representation of the virtual object on the graphical user interface.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an example system for generating tag information for tags affixable to products and for authenticating products, in communication with external components in accordance with an embodiment;

FIG. 2 is a block diagram of an example tag management system in communication with an encoding system, in accordance with an embodiment;

FIG. 3 is a flowchart of an example method for generating tag information, in accordance with an embodiment;

FIG. 4A is a schematic diagram of an example tag affixed to a product;

FIG. 4B is a schematic diagram showing example tags affixed to products belonging to the same batch;

FIG. 5 is an example genesis record generated by the tag creation system;

FIG. 6 is a block diagram of the tag creation system in communication with a database and a blockchain;

FIG. 7 is a block diagram illustrating a transfer of ownership between user devices;

FIG. 8 is a simplified block diagram of a blockchain used for tracking ownership of products and for authenticating products;

FIG. 9A is a flowchart of an example method for authenticating a product, in accordance with an embodiment;

FIG. 9B is a flowchart of an example method for authenticating a product, in accordance with another embodiment;

FIG. 9C is a schematic diagram of a portion of a tag and a database entry for a product determined to be authentic according to the method of FIG. 9B;

FIG. 9D is a schematic diagram of a portion of a tag and a database entry for a product determined to be inauthentic according to the method of FIG. 9B;

FIG. 10A is a flowchart of an example method for authenticating a product, in accordance with another embodiment;

FIG. 10B is a schematic diagram of a portion of a tag for a product determined to be authentic according to the method of FIG. 10A;

FIG. 10C is a schematic diagram of a portion of a tag for a product determined to be inauthentic according to the method of FIG. 10A;

FIG. 11 is a block diagram of a system for authenticating a product in accordance with the methods of FIGS. 9-10;

FIG. 12A is a flowchart of an example blockchain-based method for authenticating a product, in accordance with an embodiment;

FIG. 12B is a block diagram of the blockchain-based method for authenticating a product of FIG. 12A;

FIG. 12C is a schematic diagram of a portion of a smart contract and of a genesis record for a product determined to be authentic, according to the method of FIG. 12A;

FIG. 12D is a schematic diagram of a portion of a smart contract and of a genesis record for a product determined to be inauthentic, according to the method of FIG. 12A;

FIG. 12E is a schematic diagram of a portion of a smart contract and of a tag for a product determined to be authentic, according to the method of FIG. 12A;

FIG. 12F is a schematic diagram of a portion of a smart contract and of a tag for a product determined to be inauthentic, according to the method of FIG. 12A;

FIG. 13 is a block diagram of a system for authenticating a product in accordance with the methods of FIGS. 12A-12B;

FIG. 14 is an example array in a smart contract used for authenticating a product;

FIG. 15 is a plot of a mapping between serial numbers and locations of decryption key fragments;

FIG. 16 is a screenshot of an example graphical user interface of the tag creation system;

FIG. 17 is another screenshot of an example graphical user interface of the tag creation system;

FIG. 18 is a screenshot of an example graphical user interface showing a digital wallet of products owned by a user;

FIG. 19 is a screenshot of a record of ownership for a product;

FIG. 20 is a screenshot of an example webpage showing details about a product;

FIG. 21A is a screenshot of an example graphical user interface showing a product determined to be authentic;

FIG. 21B is a screenshot of an example graphical user interface showing a product determined to be inauthentic; and

FIG. 22 is a screenshot of an example virtual object associated with the product and displayed on a graphical user interface.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more elements are said to be “coupled”, “connected”, “attached”, or “fastened” where the parts are joined or operate together either directly or indirectly (i.e., through one or more intermediate parts), so long as a link occurs. As used herein and in the claims, two or more elements are said to be “directly coupled”, “directly connected”, “directly attached”, or “directly fastened” where the element are connected in physical contact with each other. None of the terms “coupled”, “connected”, “attached”, and “fastened” distinguish the manner in which two or more elements are joined together.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

High value products such as high-end jewelry, designer handbags and shoes and wines etc., are often susceptible to being counterfeited and in many cases, visual inspection alone is not sufficient to determine the authenticity of these products. To identify authentic products, manufacturers typically assign serial numbers or codes to these products that can be verified against a registry. These serial numbers and codes however can easily be copied, and the owner of the product often has a limited ability to verify that the serial number of the product in their possession is not a duplicate.

To remedy this problem, for some high value products, manufacturers affix readable encoded labels or tags that can be scanned. When scanned, information about the product can be obtained, and an indication of whether the product is authentic or not can be obtained. However, for products that are heavily susceptible to being imitated or counterfeited, traditional encoded labels can be inadequate, as they are susceptible to attacks such as full clone attacks (i.e., the entire tag for a product being duplicated) and application key attacks (i.e., encryption keys being compromised). For example, by decoding an authentic tag or label and obtaining information about the product on which the tag is affixed, it can be possible to encode new tags having the same information, which can be affixed to inauthentic products. In attempts to remedy full clone attacks, some manufacturers use tags that are encrypted with an encryption key. However, these encrypted tags are susceptible to application key attacks. For example, when a symmetric encryption-decryption key pair is used, knowledge of the decryption key can allow for the encryption key to be derived.

The embodiments described herein allow for tag information to be generated and encoded onto tags affixable to products being manufactured. The tags can be used for authentication purposes. The disclosed embodiments generate tag information at the batch-level, that is, the information to be encoded onto each tag is determined for a batch production rather than for each product within a batch. A batch corresponds to a pre-determined number of identical or similar products manufactured via batch production. By receiving batch production information and generating records for each tag to be encoded based on the batch production information, the disclosed embodiments need not generate a unique record for each product in a batch, reducing the processing power associated with generating tag information and storage requirements associated with storing tag information. The methods and systems disclosed herein then transmit instructions to an encoding system for encoding and encrypting information onto the tags. Encrypting information onto the tags can reduce the risk of the information encoded being used to reproduce tags without authorization.

The encoded tags can then be used for product authentication. Some of the disclosed embodiments allow for a product to be authenticated by an authentication server. By scanning the tag, encrypted information about the product can be obtained. As discussed in detail below, by decrypting first encrypted information and second encrypted information using a first and second decryption key stored by the authentication server and comparing the decrypted information, the authenticity of the product can be determined. By using two levels of encryption and decryption, the disclosed embodiments can provide improved safeguards against inauthentic products.

Some of the disclosed systems and methods additionally allow a product to be authenticated when the authentication server is unavailable, for example, when the entity maintaining the authentication server is no longer in operation and/or is temporarily unavailable. Reducing reliance on an authentication server can be particularly useful for products having a long lifespan and that may need to be authenticated significantly after they are manufactured. The disclosed embodiments allow a product to be authenticated without the use of the authentication server by using a blockchain-based system on which a smart contract is stored. By comparing information about the batch retrieved from a blockchain-based genesis record and from scanning a tag, the disclosed embodiments can authenticate a product without the use of an authentication server.

To prevent malicious users from deriving an encryption key that would allow the creation of new tags from a decryption key, the disclosed embodiments fragment the decryption key. In at least some embodiments, to safeguard against decryption key fragments being obtained by unauthorized users, a first decryption key fragment is transmitted to the individual claiming ownership of the product and second decryption key fragments are placed within an array in a smart contract used for authenticating the product, interspersed with artificial decryption keys that cannot be used for decryption. By transmitting information allowing retrieval of the second decryption key only to users having claimed ownership of a product, the disclosed systems and methods can prevent unauthorized users from obtaining a second decryption key fragment.

In at least some embodiments, to further safeguard against inauthentic products, the smart contract includes a bit array that keeps a record of the serial number of the products in the batch, so that products which are not part of the batch (and therefore of the bit array) are determined to be inauthentic.

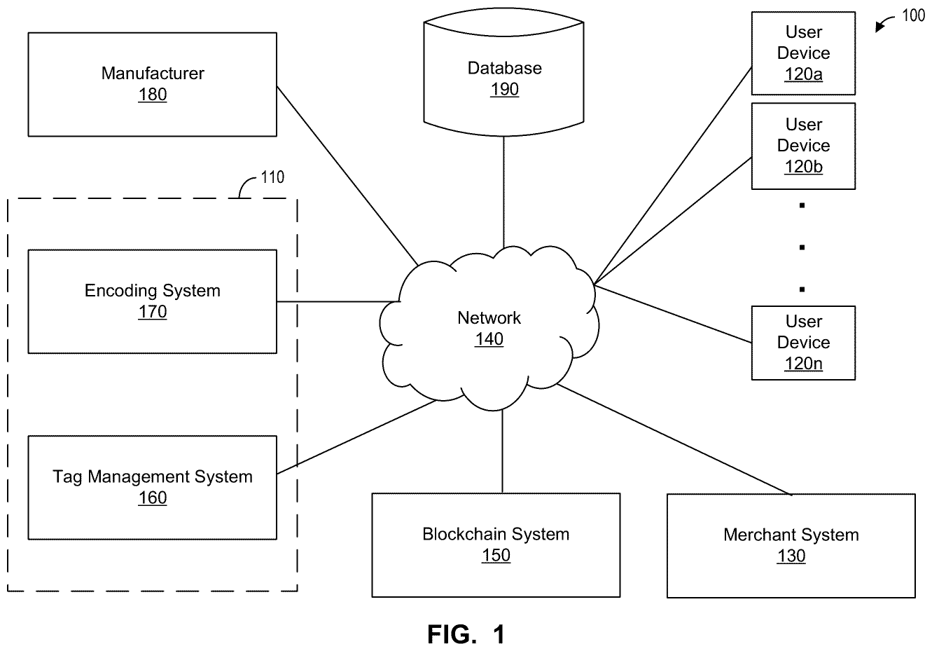

Reference is first made to FIG. 1, which shows a block diagram 100 of an authentication system. The system 100 comprises one or more communication user devices 120, a merchant system 130, a blockchain system 150, a manufacturer 180, a database 190, a tag generator and management system 110 for generating tag information for tags affixable to products and for authenticating products, and a network 140.

The tag generator and management system 110 is used to generate tags affixable to products and to authenticate products to which tags are affixed. As shown, the tag generator and management system 110 includes a tag management system 160 and an encoding system 170. By generating records containing tag information and transmitting instructions for encoding the records on tags to the encoding system 170, encoded tags can be created, which can be affixed to products. The encoded tags can then be scanned at a later time, to determine the authenticity of the product to which the tags are affixed.

The tag management system 160 is a system for creating tag information and for authenticating tags when the tags are affixed to products. The tag management system 160 obtains information relating to batches of products to be tagged, generates and/or retrieves cryptographic keys to encode information relating to the batches, generates records for the products and determines and transmits instructions to the encoding system 170 to encode the records onto tags.

The encoding system 170 receives encoding information and instructions form the tag management system 160 and encodes information onto tags affixable to products. The encoding system 170 can include an encoding machine that receives instructions for encoding tags and carries out the encoding process.

Each user device 120 can couple to the network 140 through a wired or wireless connection to communicate with the blockchain system 150 and the tag management system 160. Each user device 120 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. Each user device 120 can be associated with an individual seeking to claim ownership over a product, authenticate a product, and/or to transfer ownership of a product though each individual can be associated with more than one user device 120. For example, the user device 120 can correspond to a mobile device, a portable computer. The user devices 120 can be used to retrieve information on tags affixed to products. The user devices 120 can be equipped with wireless scanning functionalities that allow the user devices 120 to read information encoded on tags. The user devices 120 can be used to access the blockchain system 150 to transfer ownership of tokens representative of products and to authenticate products and to receive information from the tag management system 160.

The merchant system 130 can be associated with a merchant, for example, a merchant selling products. In some cases, the merchant system 130 can be associated with a merchant wallet and the merchant system 130 can transfer ownership of a product to an individual associated with a user device 120.

The network 104 may be any network that allows each of the components of the system 100 to communicate. The network 104 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between each of the components of the system 100.

The blockchain system 150 can be a public blockchain. The blockchain can use any proof-of-stake protocol.

The manufacturer 180 corresponds to the manufacturer of a batch of product. The manufacturer 180 can transmit instructions to the system 110 for generating tag information for tags affixable to products and for authenticating product information about the products being manufactured by the manufacturer 180.

The database 190 can store any information relating to batches and/or products. The database 190 can also store any information that can be used by an authentication system to authenticate a product. For example, for each batch, the database 190 can maintain a record of a batch identifier corresponding to the batch production in the manufacturing process, a product identifier corresponding to the product manufactured in the batch production, a batch creation time corresponding to a time of completion of the batch production and a product count corresponding to number of products yielded in the batch production. The database 190 can store encryption and decryption keys for encrypting and decrypting tag information, as discussed below. The database 190 can additionally store information relating to ownership of products. For example, when a product is claimed by an individual, the database 190 can record the owner of the product. Each time the product is transferred to another individual, the database 190 can record the transfer of ownership.

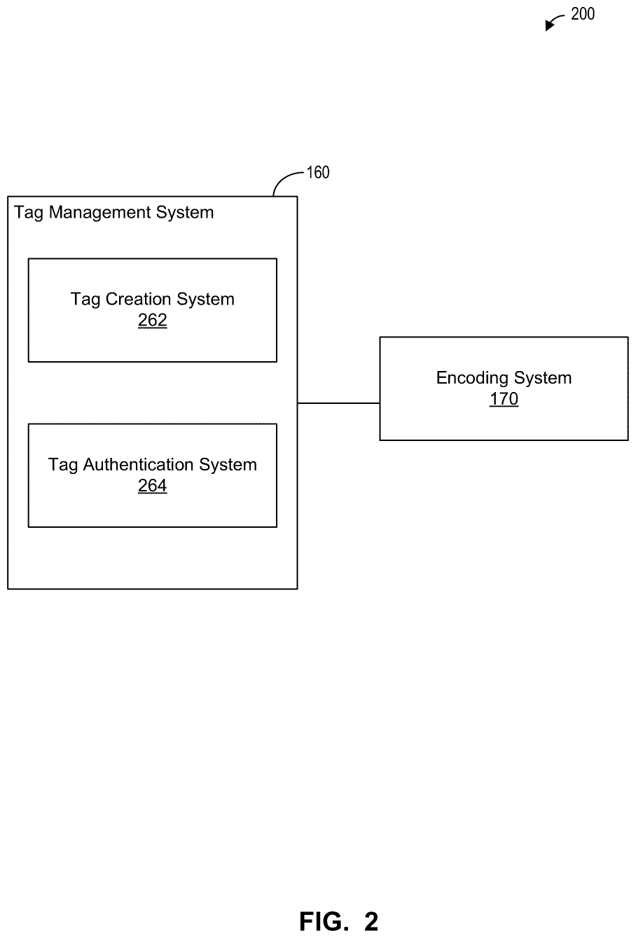

Referring now to FIG. 2, there is shown a block diagram of the tag management system 160 in communication with the encoding system 170. As shown in the example of FIG. 2, the tag management system 160 includes a tag creation system 262 and a tag authentication system 264. The tag management system 160 can communicate with the encoding system 170 via a network, such as network 140 (not shown in FIG. 2).

The tag creation system 262 is configured to generate a record for each tag to be encoded by the encoding system 170 and instructions for the encoding system 170 to encode information onto tags. The tag creation system 262 can receive information related to a batch from a manufacturing system of the manufacturer 180 and generate a record for each product to which a tag is to be affixed. The tag creation system 262 can generate cryptographic pairs used to encrypt information on portions of the records encoded on the tags.

The tag authentication system 264 is configured to authenticate products. The tag authentication system 264 can be in communication with a database such as database 190 or a database dedicated to the tag authentication system 264 that can be accessed by the tag authentication system 264 to determine the authenticity of a product. User devices 120 can communicate with the tag authentication system to transmit information relating to products and the tag authentication system 264 can determine, based on information received, the authenticity of a product.

Each of the tag creation system 262, the tag authentication system 264 and the encoding system 170 can include a processor that controls the operation of each of the systems. Each processor is configured to provide sufficient processing power depending on the configuration, purposes and requirements each of the systems.

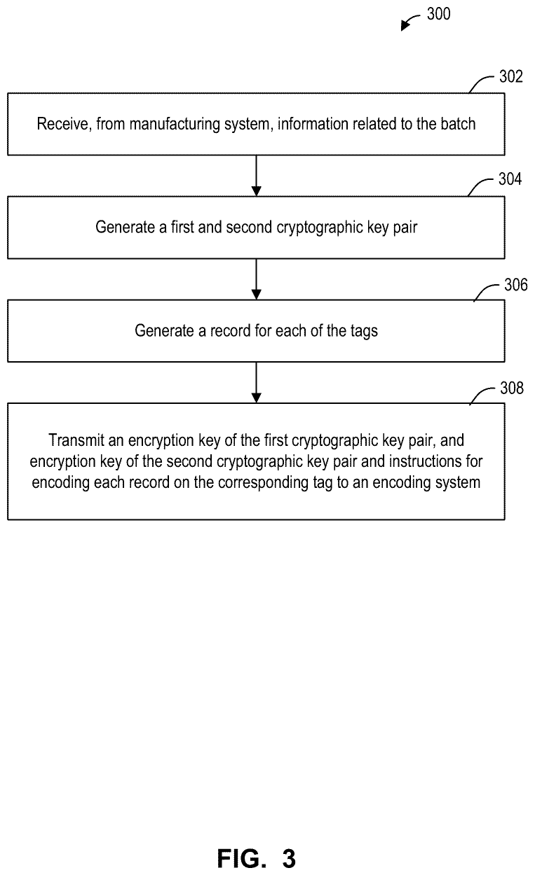

Referring now to FIG. 3, there is shown a flowchart of an example method 300 for generating tag information. Tag information can be transmitted to an encoding system such as encoding system 170 that can encode the tag information onto tags that can be affixed to products. The method 300 can be performed by a processor of the tag creation system 262.

At 302, the tag creation system 262 receives from a manufacturing system, information related to a batch of products. The manufacturing system can correspond to a system operated by a manufacturer 180 of the batch of products. For example, the manufacturer 180 of a batch of products can register the batch and the products in the batch and request for tag information to be generated. Information related to the batch of products can include any information characterizing the batch and/or the products in the batch, such as, but not limited to, a batch identifier identifying the batch of products, a product identifier identifying the products manufactured by batch production, a batch creation time corresponding to the time of completion of the batch production, and a product count corresponding to the number of products yielded in the batch. In some embodiments, at least some information related to the batch of products is stored in the database 190. The database 190 can be accessed at a later time, for example, during a product authentication process.

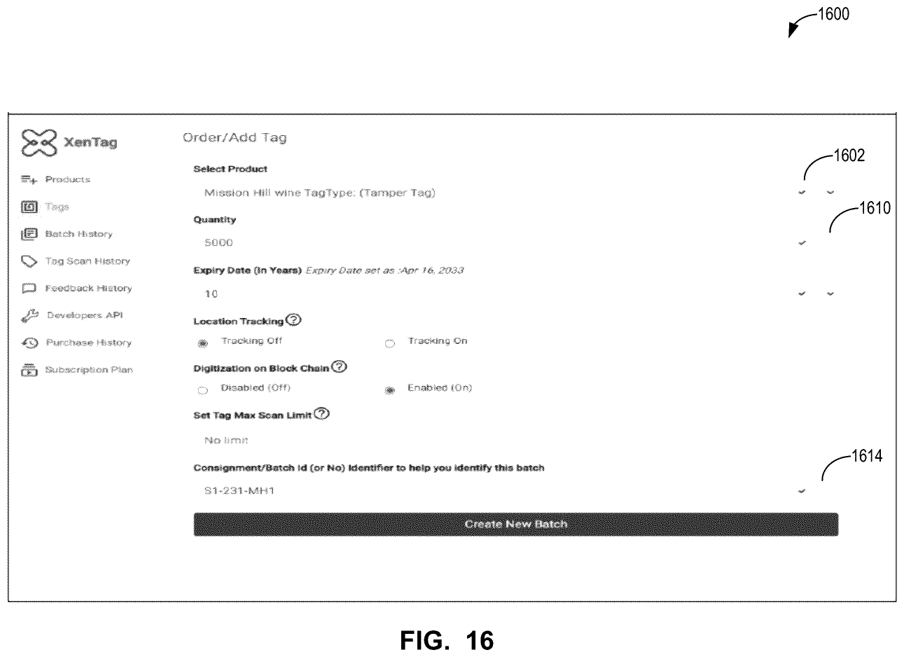

Referring briefly to FIG. 16, shown therein is a screenshot of an example graphical user interface (GUI) 1600 of the tag creation system 262. A user associated with the tag creation system 262 can for example, interact with the GUI 1600 to create tag information for a batch. As shown, the product 1602 for which tags are being created, the quantity 1610 of products manufactured in the batch (i.e., batch size), and a batch ID 1614 for the batch can be specified. Additional information can be specified, depending on the type of product for which tags are generated. In some embodiments, at least some information relating to the batch can be pre-specified and/or received from the manufacturing system. Based on the information specified, the tag creation system 262 generates tag information.

Returning to FIG. 3, at 304, the tag creation system 262 generates and/or retrieves from a database a first and a second cryptographic public-private key pair for the batch of products. In some embodiments, the first cryptographic key pair is an Advanced Encryption Standard (AES) symmetric cryptographic key pair. The second cryptographic pair can be an asymmetric key pair. Each of the first and second cryptographic key pairs are unique to the batch of products.

At 306, the tag creation system 262 generates a record for each tag to be encoded. In various embodiments illustrated herein, each product in the batch receives a corresponding unique tag. The tags can be any type of tag that can be encoded with information and from which information can be read, including but not limited to NFC tags and RFID tags.

At 308, the tag creation system 262 transmits to the encoding system the encryption key of the first cryptographic key pair and instructions for encrypting unique first encryptable information in a first portion of the record for each tag using the encryption key of the first cryptographic key pair. The tag creation system 262 additionally transmits to the encoding system 170 the encryption key of the second cryptographic key pair and instructions for encrypting unique second encryptable information in a second portion of the record using the encryption key of the second cryptographic key pair.

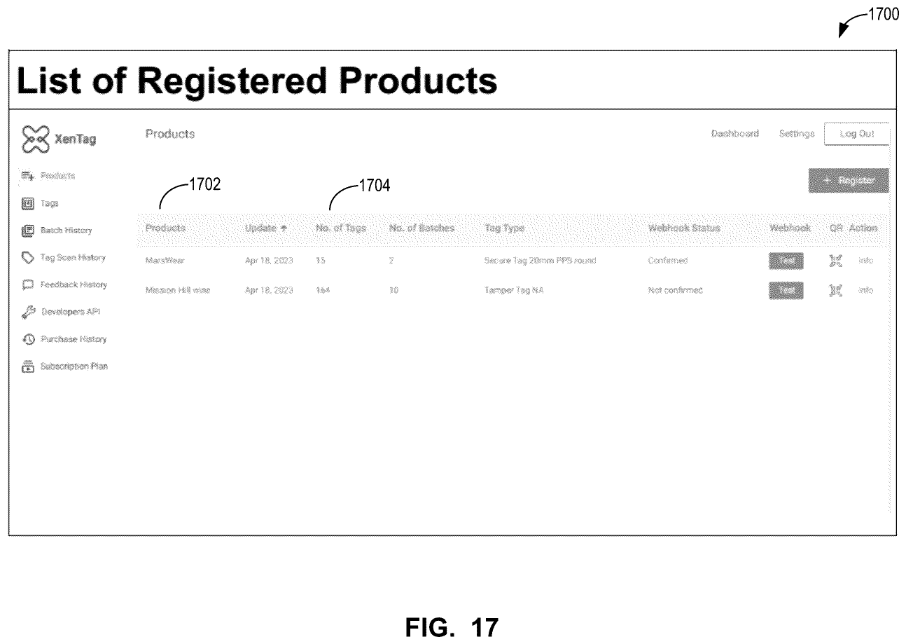

The tag creation system 262 can keep records of batches for which tag information has been generated, as shown in the example of FIG. 17, which shows a screenshot of an example graphical user interface 1700 of the tag creation system 262. FIG. 17 shows the GUI 1700 of a tag creation system 262 that has created tags for two different products 1702, each having a different number of tags 1704 (i.e., different batch sizes).

In some embodiments, for each record, the first encryptable information includes a tag identifier of the tag on which the record is encoded. The tag identifier can be a universally unique identifier (UUID) identifying the tag. Accordingly, transmitting instructions for encrypting unique first encryptable information in a first portion of the record can involve transmitting instructions for encrypting a tag identifier of the tag in a first portion of the record. In some other embodiments, the first encryptable information includes a tap count field, which is indicative of the number of times the tag has been scanned. In some embodiments, the first encryptable information additionally includes a checksum field that can be used for authenticating a tag.

In some embodiments, for each record, the second encryptable information includes a chain identifier that includes the batch creation time and a serial number of the tag corresponding to a sequential number of the tag in the batch. In some embodiments, the chain identifier additionally includes the tag identifier. Accordingly, transmitting instructions for encrypting unique second encryptable information in a second portion of the record can involve transmitting instructions for encrypting a chain identifier in a second portion of the record.

In at least some embodiments, during method 300, only tag information relating to the batch is stored in the database 190 and information specific to a tag (e.g., tag identifier, tap count, checksum, serial number of the tag) is not stored in the database 190 when the tag information is generated. The storage of batch information only reduces storage requirements associated with storing tag information and avoids storing information relating to tags that may not be used for product authentication (e.g., tags affixed to products that are never sold, tags affixed to products that are not authenticated, tags that are not affixed to products due to changes in batch size).

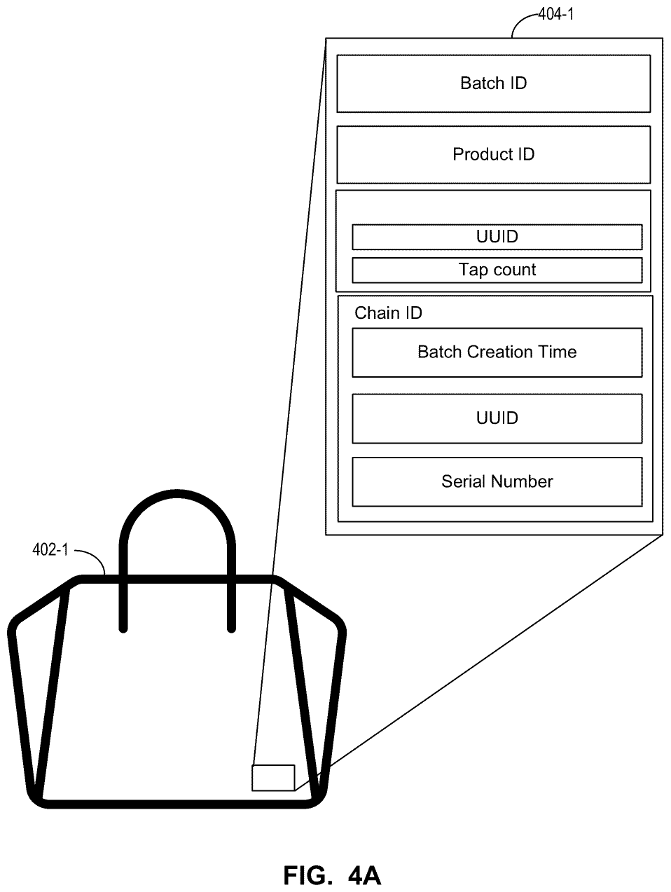

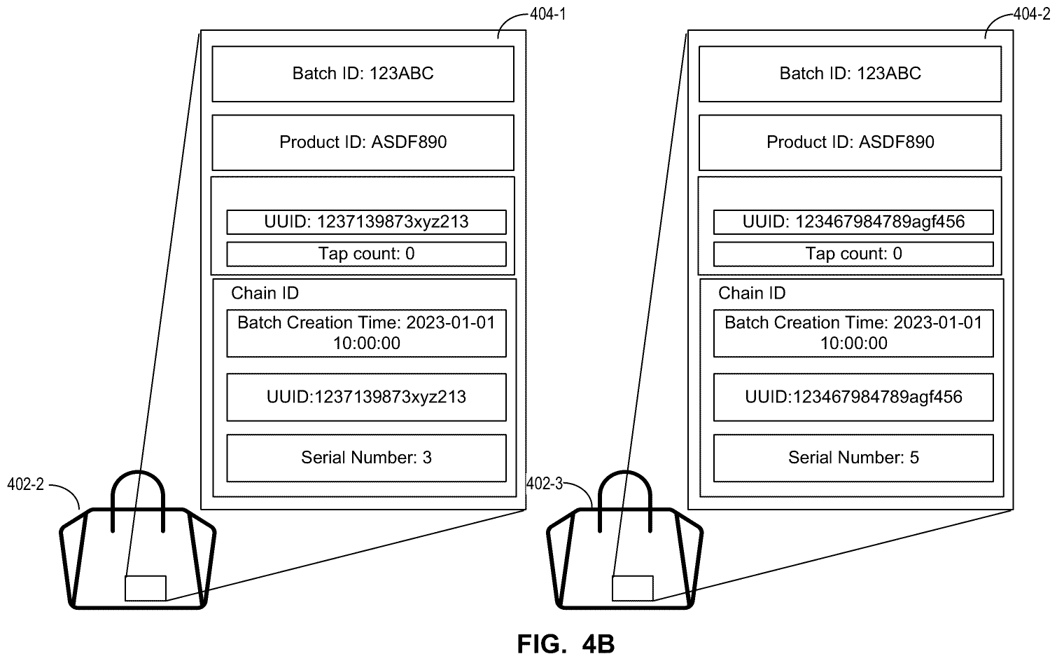

Referring briefly to FIG. 4A, there is shown an example of a product 402-1 to which a tag 404-1 is affixed. As shown in the example of FIG. 4A, the tag 404-1 is encoded with information related to the batch, including a batch identifier, a product identifier, a UUID identifying the tag, a tap count and a chain identifier. The tap count can be a writable field that is updated each time the tag is scanned. For example, the tap count can indicate the number of times that the tag has been scanned. As shown, the chain ID includes the batch creation time, the UUID, and a serial number identifying the tag.

Referring briefly to FIG. 4B, there is shown example tags 404-2, 404-3 for two products 402-2, 402-3 belonging to the same batch. As shown, since the products 402-2, 402-3 belong to the same batch, the batch identifier, product identifier and batch creation time encoded on both tags 404 is identical, while the UUID and serial number, which are specific to each tag differ. Since at the time of tag creation, the tags have not been scanned yet, the tap count on both tags 404 is set to “0”.

In some embodiments, once the tags are encrypted by the encryption keys, the encoding system 170 discards the encryption key of the second cryptographic key pair. Discarding the encryption key can prevent additional tags from being encrypted and being affixed to inauthentic products. For example, a counterfeiter may attempt to encrypt information related to the batch onto a genuine tag affixed to a counterfeit product. By discarding the encryption key, additional tags may not be generated.

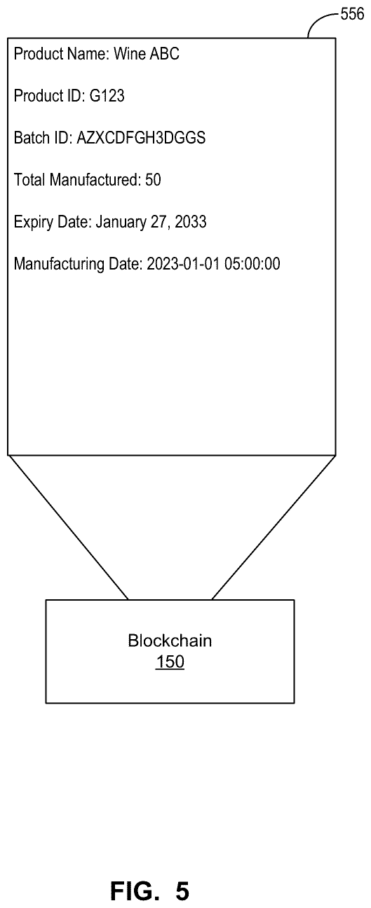

In some embodiments, the tag creation system 262 generates a genesis record containing the information related to the batch production and stores the genesis record on a block in the blockchain system 150. The tag creation system 262 generates one genesis record for each batch. FIG. 5 shows an example genesis record 556 for a batch, that can be stored on the blockchain system 150. The address of the genesis record on the blockchain can be recorded by the tag creation system 262 (e.g., stored in the database 190). The genesis record can be used to obtain information about the batch to which a product belongs and/or for authenticating a product, as will be described in further detail with respect to methods 900, 1000 and 1200.

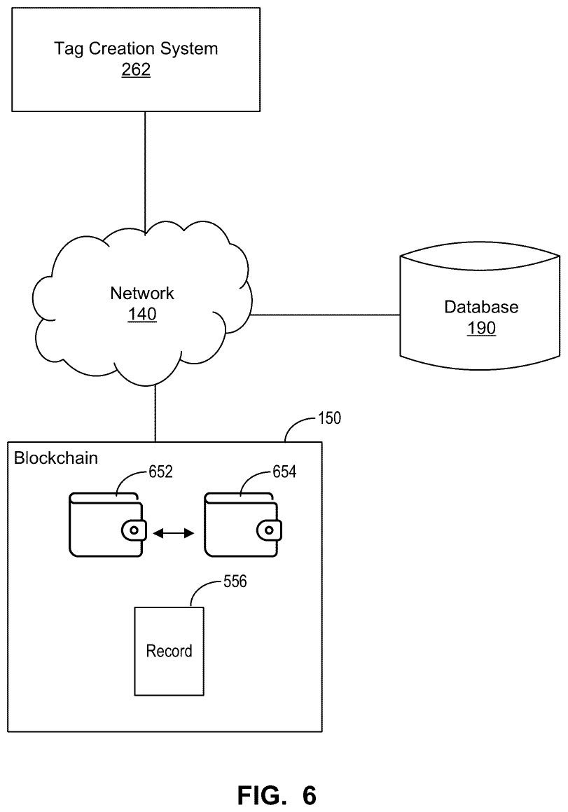

Referring briefly to FIG. 6, there is shown a block diagram of the tag creation system 262 in communication with the database 190 and the blockchain system 150 via the network 140. As shown in the example of FIG. 6, generating the genesis record 556 involves initiating a transaction between a first blockchain wallet 652 and a second blockchain wallet 654. The blockchain wallets 652, 654 can belong to the same entity, for example, the tag management system 160 or to different entities.

In some embodiments, the tag management system 160 can receive claims of ownership signals from user devices 120. Each claim of ownership signal corresponds to an individual claiming ownership over a product in a batch. For example, upon purchasing or receiving a product to which a tag is affixed, the owner of the product may scan the tag or otherwise retrieve information from the tag to claim ownership over the product to indicate that the product is owned by the individual. In some example embodiments, scanning the tag can direct the user to a webpage prompting the user to claim the product.

Upon receiving a claim of ownership for a product, a blockchain token representative of the product can be generated on the blockchain by a blockchain wallet. The token can be used as a proof of ownership of the product and can be used to access information required for authenticating the product. The token can be assigned to a blockchain wallet associated with or belonging to the individual claiming ownership of the product and can be accessible via the user device 120 associated with the individual. For example, the tag management system 160 can create a wallet for the individual and transfer the token from the wallet generating the token to the wallet of the individual. The token can be a non-fungible token that is exchangeable and can include information about the product and the serial number of the tag. In some embodiments, the token additionally includes the address of the genesis record and/or of a smart contract used for authenticating the tag.

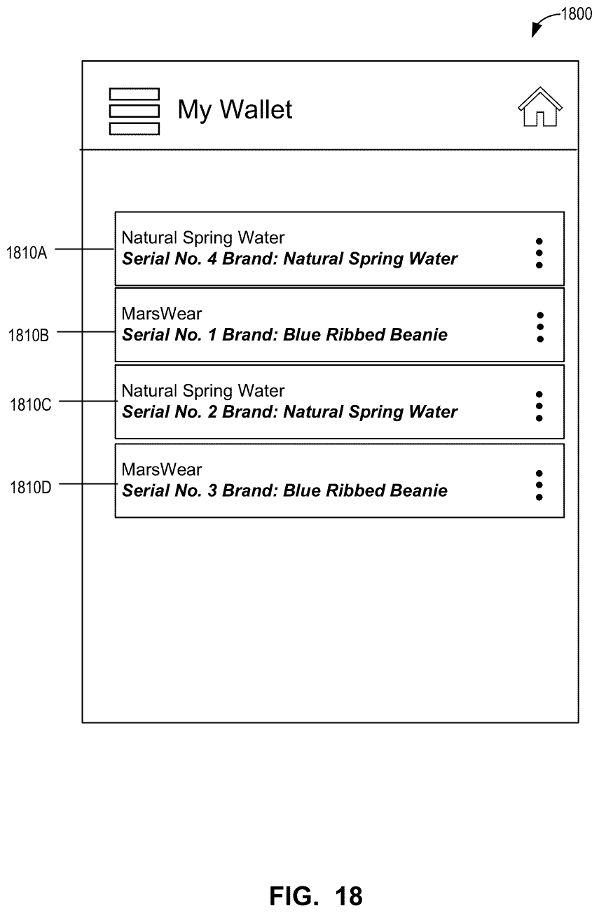

Referring briefly to FIG. 18, there is shown a screenshot of an example graphical user interface 1800 displaying products owned by an individual. As shown, each product owned by the individual can be associated with an item 1810 in a digital wallet. Each item 1810 can be associated with a token representative of the product.

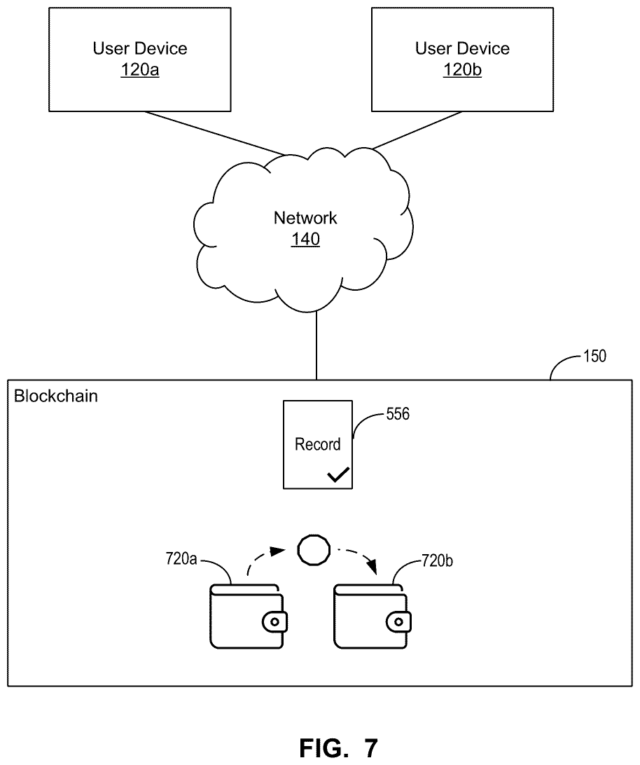

Referring briefly to FIG. 7, which shows a first user device 120a and a second user device 120b in communication with the blockchain system 150 via the network 140, the token can be transferred from a first wallet 720a associated with the first user device 120a to a second wallet 720b associated with the second user device 120b. For example, when a product is transferred (e.g., sold, gifted) from a first individual to a second individual, the first individual can transfer the token representative of the product to the second individual, so that the second individual is in possession of the product and the token representative of the product. Each of the wallets can be wallets on the blockchain that can be accessed by the user devices 120.

In some embodiments, when a token is transferred between a first wallet 720a and a second wallet 720b, the tag management system 160 receives an indication of a transfer of ownership from the user device 120 associated with the wallet 720 transferring the token. This indication of transfer of ownership can be recorded in the database 190, which can record ownership information.

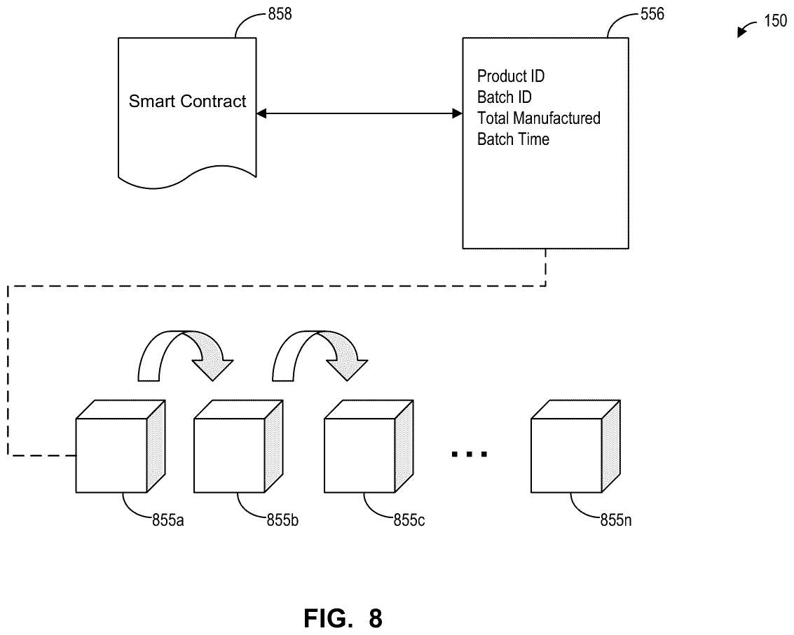

In some embodiments, the transfer of ownership is additionally recorded in the blockchain. When a token is transferred from a first wallet 720a to a second wallet 720b, a transaction can be initiated on the blockchain system 150 and a block 855 can be appended to the blockchain system 150, as shown in FIG. 8, which shows a simplified diagram of the blockchain system 150. By going through the blockchain, the genesis record 556 can be retrieved, via a pointer in the first block 855a of the blockchain.

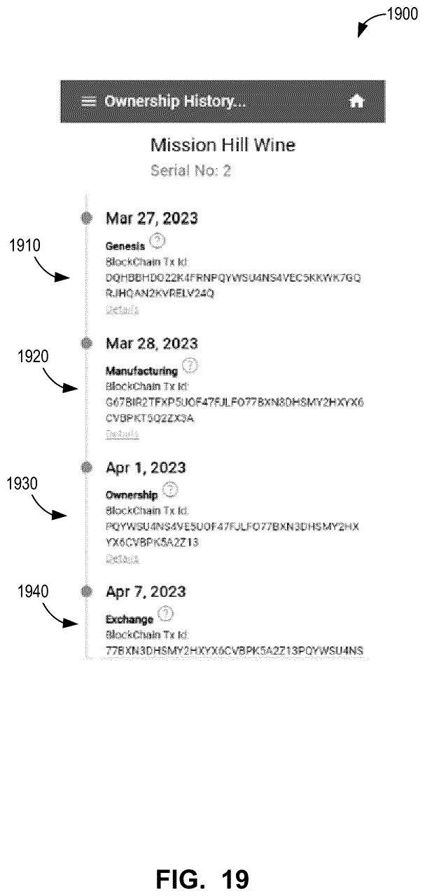

Referring to FIG. 19, there is shown a screenshot of an example graphical user interface 1900 showing the history of events associated with a product. As shown, at 1910, the genesis record for the product is created on the blockchain. At 1920, the tag is encoded and associated with the genesis record. At 1930, a claim of ownership is made and at 1940, ownership of the product is transferred.

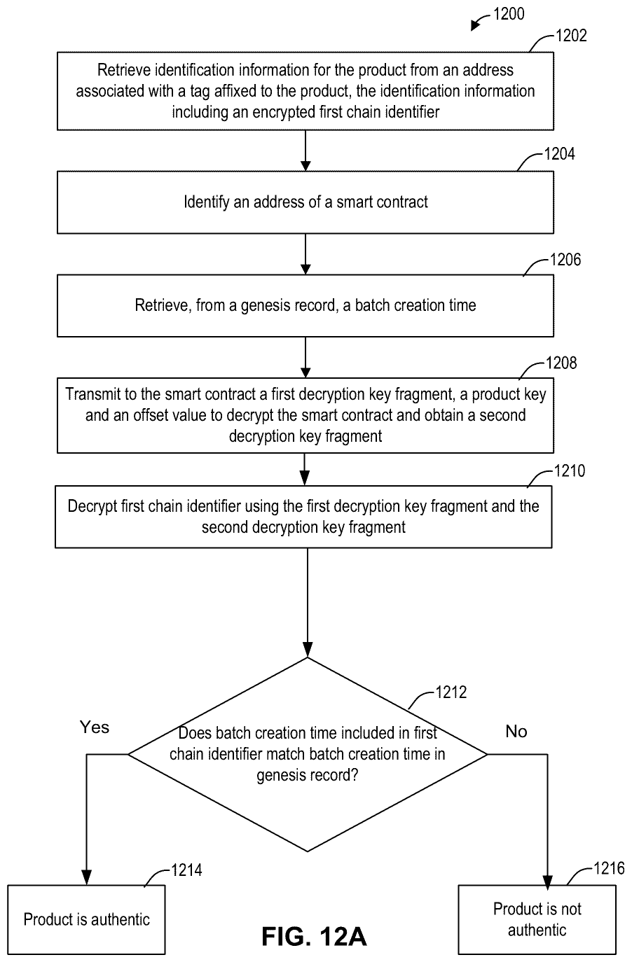

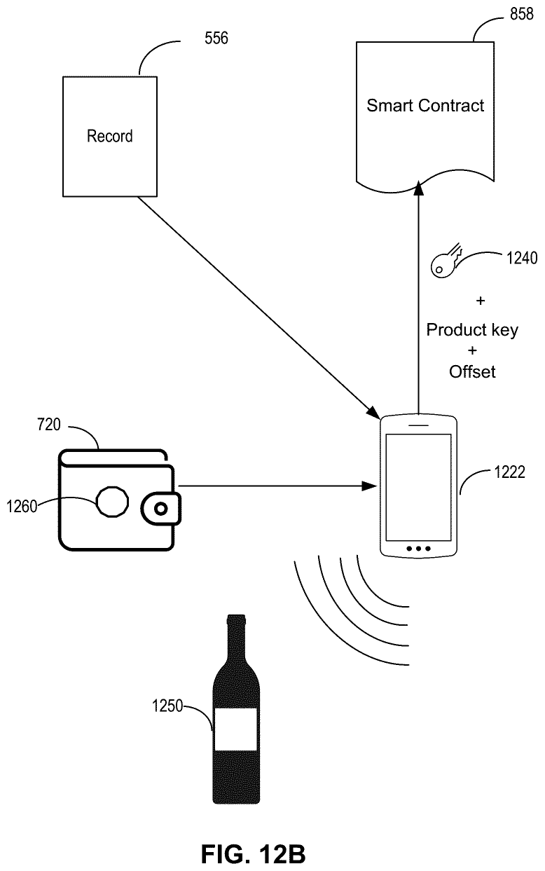

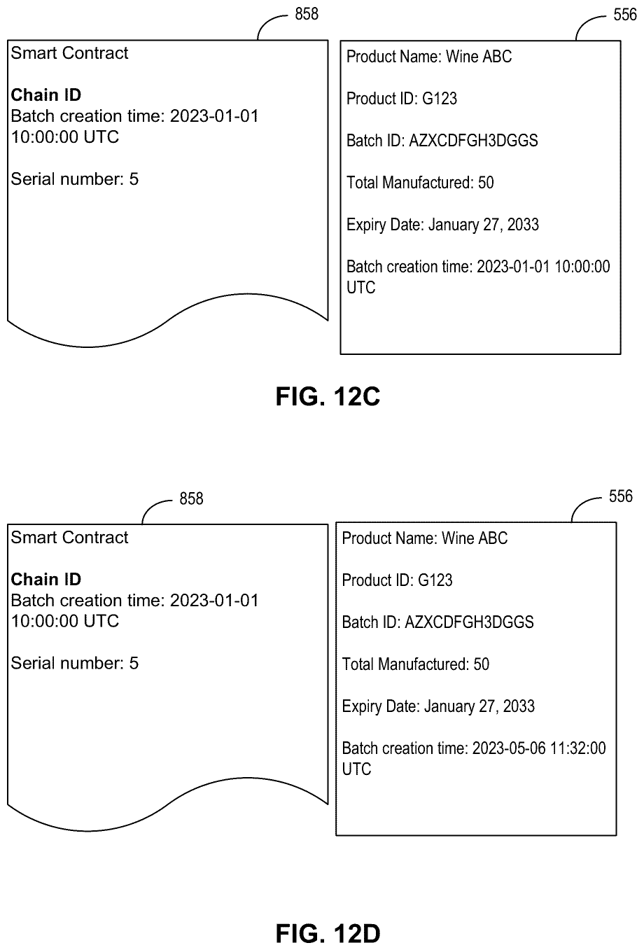

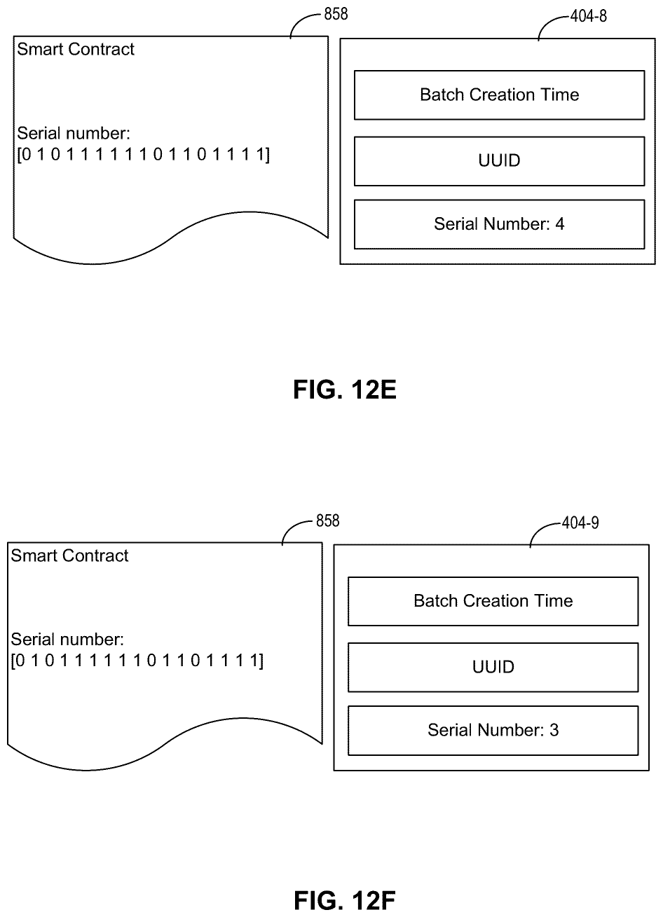

In some embodiments, a smart contract associated with the batch production is generated when a first claim of ownership is received by the tag management system 160. The first claim of ownership can be indicative that the batch of products is available to be claimed. The smart contract can be used for authenticating products when the products cannot be authenticated by the tag management system 160, for example, when the tag management system 160 is unavailable or no longer available, as will be described in further detail with reference to FIG. 12.

In some embodiments, the token representative of the product includes a pointer to the genesis record 556 and/or to the smart contract used for authenticating products. By including a pointer to the genesis record 556, information related to the batch can be viewed and/or retrieved by an individual having access to the token, via a user device 120.

In some embodiments, when a claim of ownership over each of the products in a batch is received by the tag management system 160 or of a predetermined number of products in the batch, or at a predetermined time following the batch creation time, the tag management system 160 fragments the decryption key of the second cryptographic key pair into fragments. The number of fragments can vary and can correspond for example, to the number of products in the batch or the number of products claimed within the predetermined time window so that each product in the batch is associated with a different fragment, though in some cases, a fragment can be duplicated, for example, if the number of products in a batch is very large. Each fragment can be transmitted to a user device associated with a claim of ownership. One or more fragments can be retained (i.e., not distributed to user devices having claimed ownership of products) and stored in the smart contract generated. Fragmenting the decryption key can prevent the encryption key from being derived from the decryption key and therefore prevent a malicious actor who has obtained a decryption key from deriving the encryption key and creating new tags and affixing the new tags to inauthentic products.

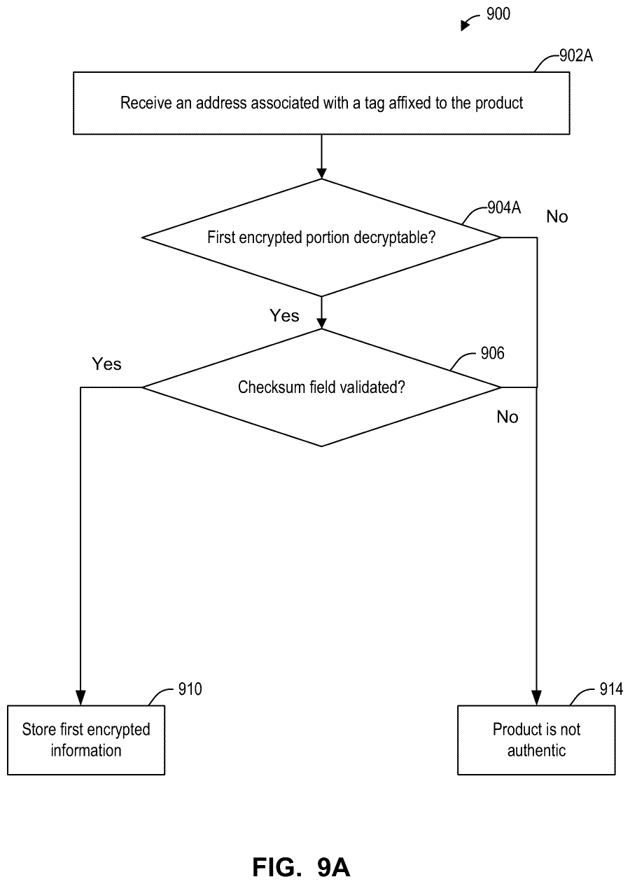

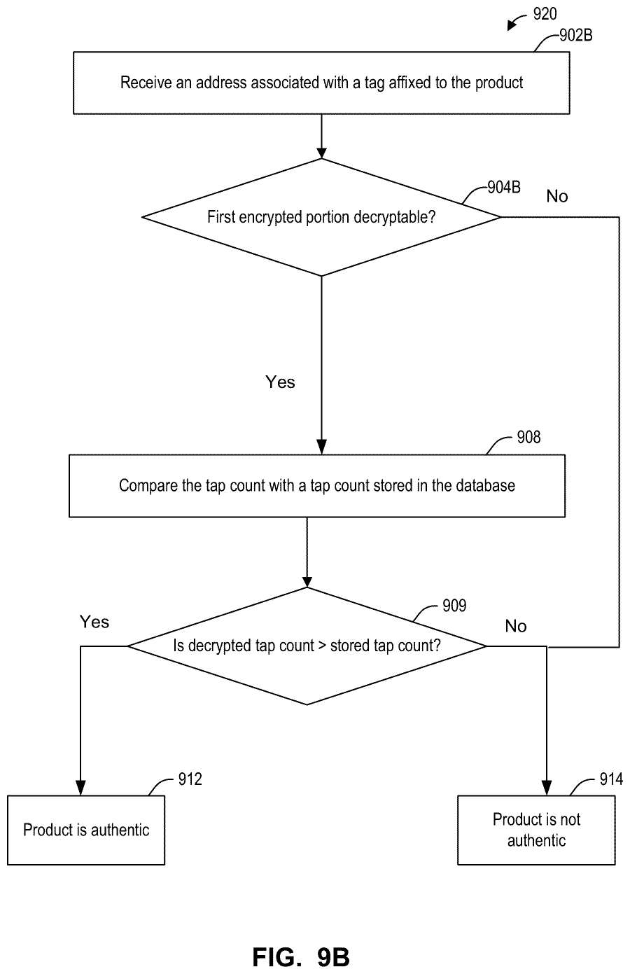

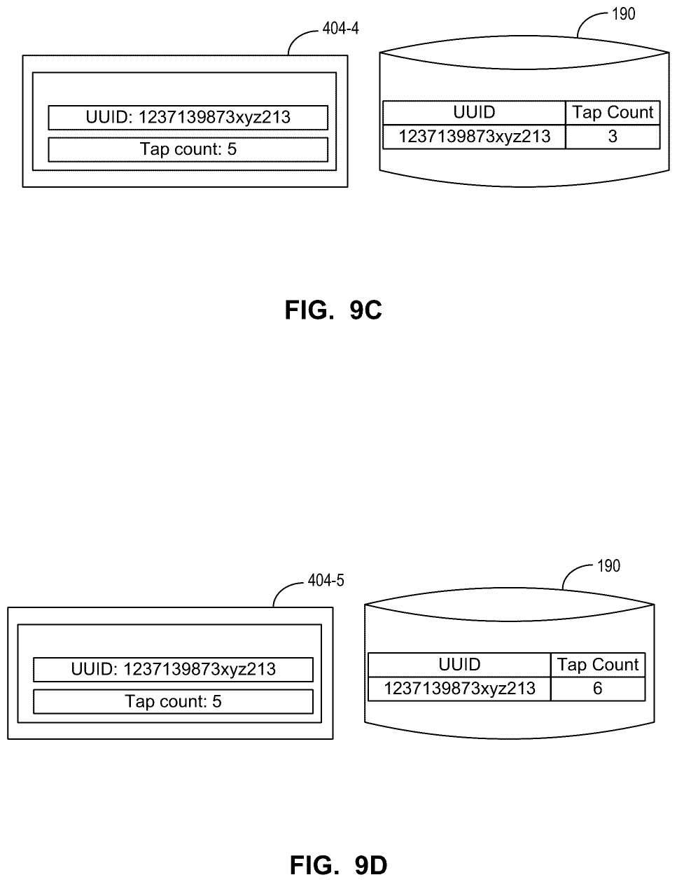

Referring now to FIG. 9A, there is shown a flowchart of a method 900 of authenticating a product. The method 900 can be executed when a product is authenticated for the first time.

At 902A, the tag authentication system 264 receives, from a computing device, an address associated with the tag affixed to the product being authenticated. The computing device can be a user device 120.

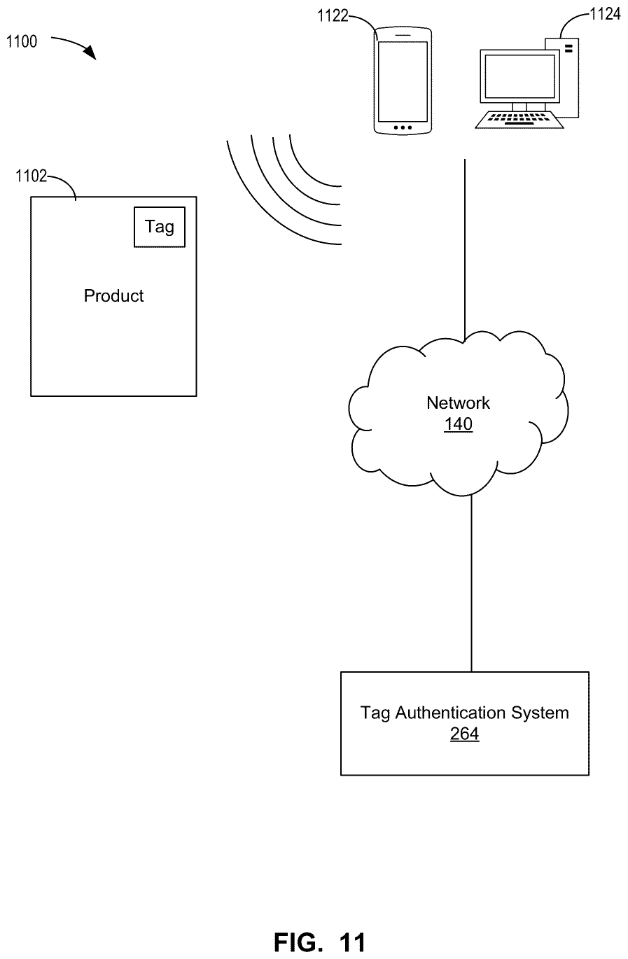

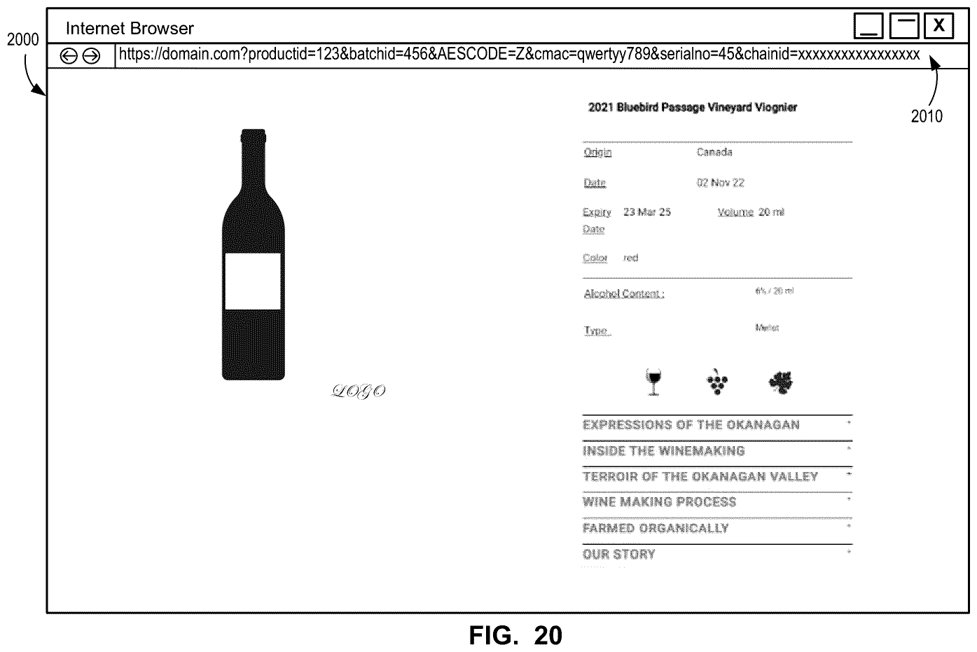

Reference is briefly made to FIG. 11, which shows a block diagram 1100 of the components used to perform the method 900. As shown, example computing devices 1122 and/or 1124 can be used to wirelessly scan the tag affixed to product 1102. As described, the tag can be a wirelessly readable tag and the computing devices 1122, 1124 can be any device capable of wirelessly scanning the tag to retrieve an address of the tag. The address can be parsed by the authentication system 264 and can include identification information about the product. Identification information can include a product identifier identifying the products or the types of products in the batch, the batch identifier identifying the batch production, the serial number of the tag and/or any combination of these. In some cases, when the address is parsed, the user is redirected to a webpage that additionally includes information about physical attributes of the product (e.g., size, color, volume), logos associated with the products and/or photographs of the product as shown in FIG. 20, which shows a screenshot of an example page 2000 generated when parsing the address. In the example of FIG. 20, the address is an URL 2010 that directs to a page showing details about the product on which a tag is affixed.

In some embodiments, the address can be a uniform resource locator (URL) or a uniform resource identifier (URI) that is created by the tag creation system 262 or by the manufacturer 180 of the product and stored in a decentralized system such as the InterPlanetary File System (IPFS).

At 904A, the authentication system 264 decrypts a first encrypted portion of the address using a first decryption key to obtain first decrypted information. In some embodiments, the first decryption key is retrieved from a database. In other embodiments, the first decryption key is located on the tag. If the first encrypted portion of the address is successfully decrypted, the authentication system 264 proceeds to 906. If the first encrypted portion is not successfully decrypted, the product is determined to be inauthentic at 914.

In some embodiments, the first decryption key is retrieved using the product identifier and/or the batch identifier identified at 902 when the address associated with the product is retrieved. For example, the first decryption key can be stored in the database 190 in association with the product identifier and/or the batch identifier. The first decryption key corresponds to the decryption key of the first cryptographic key pair used during the tag creation process described with reference to method 300.

In some embodiments, the first decrypted information corresponds to a tag identifier identifying the tag affixed to the product being scanned. As discussed above, the tag identifier can be a UUID. In some other embodiments, the first decrypted information corresponds to a tag identifier identifying the tag affixed to the product and a tap count indicative of the number of times the tag has been scanned.

At 906, the authentication system 264 verifies the checksum field of the first decrypted information. The checksum field is a known value that is generated for the tag identifier and the tap count of the tag. If the checksum field is validated (i.e., the checksum field corresponds to the known value), the product is determined to be authentic, and the method proceeds to 910. Otherwise, the product is determined to be inauthentic at 914.

At 910, the authentication system 264 stores an entry for the authenticated tag in the database 190. The entry can include the first decrypted information (e.g., the tag identifier and the associated tap count). Storing information specific to a tag (e.g., first decrypted information) only when the tag is first scanned can reduce storage requirements, since information about tags that are never scanned is not stored.

Referring now to FIG. 9B, there is shown a flowchart of a method 920 of authenticating a product. In some embodiments, method 920 is executed after method 900 has been executed once. Accordingly, in such embodiments, method 920 is executed when the product has already been authenticated once.

At 902B, similar to 902A, the tag authentication system 264 receives, from a computing device, an address associated with the tag affixed to the product being authenticated. The computing device can be a user device 120.

At 904B, similar to 904A, the authentication system 264 decrypts a first encrypted portion of the address using a first decryption key to obtain first decrypted information. The first encrypted information includes a tag identifier for the tag and a tap count of the tag. If the authentication system 264 successfully decrypts the first encrypted portion, the method 920 proceeds to 908.

At 908, the authentication system 264 compares the tap count determined at 904B with a tap count associated with the tag identifier obtained at 904B stored in the database 190. As described, each time the tag is scanned, the tap count is updated (e.g., incremented) on the tag.

At 909, the authentication system 264 determines whether the product is authentic based on the comparison. For example, if the tap count determined at 904B is greater than the tap count stored in the database (i.e., the tap count increases), the authentication system 264 determines at 912 that the product is authentic. If the tap count determined at 904B is equal or less than the tap count stored in the database (i.e., the tap count does not increase), the authentication system 264 determines at 914 that the product is not authentic. A determined tap count that is not greater than the tap count stored in the database can be indicative that the tag is not genuine and therefore that the product may or may not be authentic.

Referring now to FIGS. 9C-9D which show a portion of a tag 404-4 and a portion of a tag 404-5, respectively, the product associated with tag 404-4 is determined using the method 920 to be authentic, since the tap count on the tag 404-4 is greater than the tap count stored in the database 190. By contrast, the product associated with the tag 404-5 shown in FIG. 9D is determined using method 920, to be inauthentic, since the tap count on the tag 404-5 is not greater than the tap count stored in the database 190.

If the tag is determined to be authentic, the tap count obtained at 904B is stored in the database, for future comparisons.

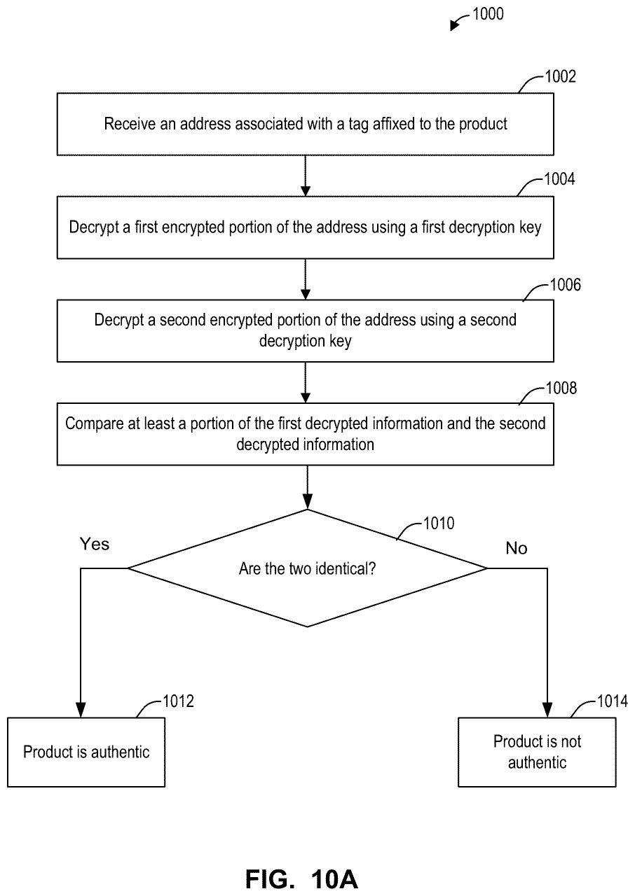

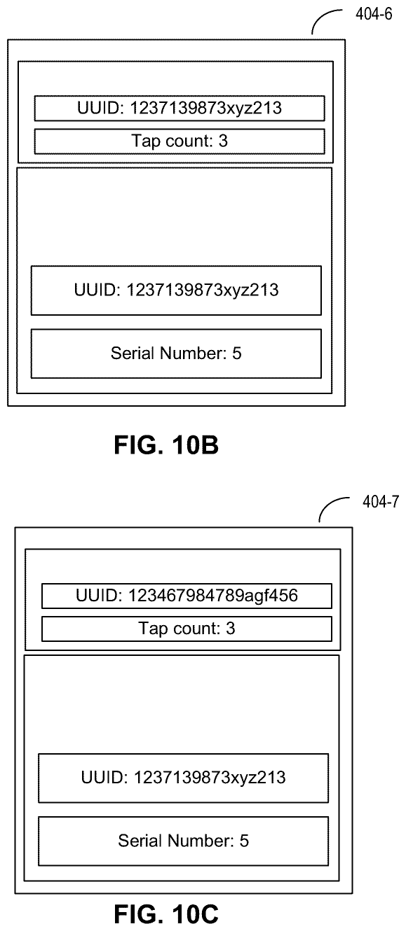

Referring now to FIG. 10A, there is shown a flowchart of a method 1000 for authenticating a product associated with a batch production in a manufacturing process, for example a product to which a tag created using the method 300 is affixed. The method 1000 can be performed by the tag authentication system 264 of the tag management system 160. Method 1000 can be executed in combination with methods 900 and 920. For example, method 1000 can be executed following methods 900 and/or 920.

At 1002, similar to 902, the tag authentication system 264 receives, from a computing device, an address associated with the tag affixed to the product being authenticated. The computing device can be a user device 120.

At 1004, similar to 904, the authentication system 264 decrypts a first encrypted portion of the address using a first decryption key to obtain first decrypted information. The first decryption key can be stored in a database of the authentication system 264 and/or of the tag management system 160 or can be stored on the tag. The first decryption key corresponds to the decryption key of the first cryptographic key pair used during the tag creation process described with reference to method 300.

At 1006, the authentication system 264 decrypts a second encryption portion of the address using a second decryption key to obtain second decrypted information. The second decryption key can be stored in a database of the authentication system 264 and/or of the tag management system 180 and can be stored at the time of encryption.

In some embodiments, the second decrypted information includes the chain identifier of the tag, which in some embodiments, includes the batch creation time, the tag identifier and the serial number of the tag. As discussed above, the tag identifier included in the chain identifier can be a UUID. In some other embodiments, the chain identifier includes the batch creation time and the serial number of the tag.

At 1008, the authentication system 264 compares at least a portion of the first decrypted information and the second decrypted information.

In some embodiments, the authentication system 264 compares the tag identifier of the first decrypted information and the tag identifier derived from the chain identifier of the second decrypted information.

At 1010, the authentication system 264 determines whether the product is authentic based on the result of the comparison. For example, if both the tag identifiers of the first decrypted information and the second decrypted information are identical, the authentication server 264 determines at 1012 that the product is authentic.

Alternatively, if the tag identifiers of the first decrypted information and the second decrypted information are not identical, the authentication system 264 determines at 914 that the product is not authentic.

Referring briefly to FIGS. 10B-10C, which show portions of tags 404-6 and 404-7, respectively, the product associated with tag 404-6 is determined, using method 1000, to be authentic, since the tag identifier of the first decrypted information and the tag identifier of the second decrypted information match. By contrast, the product associated with tag 404-7 is determined to be inauthentic, since the tag identifier of the first decrypted information and the tag identifier of the second decrypted information do not match.

In some embodiments, the authentication system 264 additionally compares the serial number of the second decrypted information and the serial number in the address received at 1002. If the serial numbers match, the product is determined to be authentic. If the serial numbers do not match, the product is determined to be inauthentic.

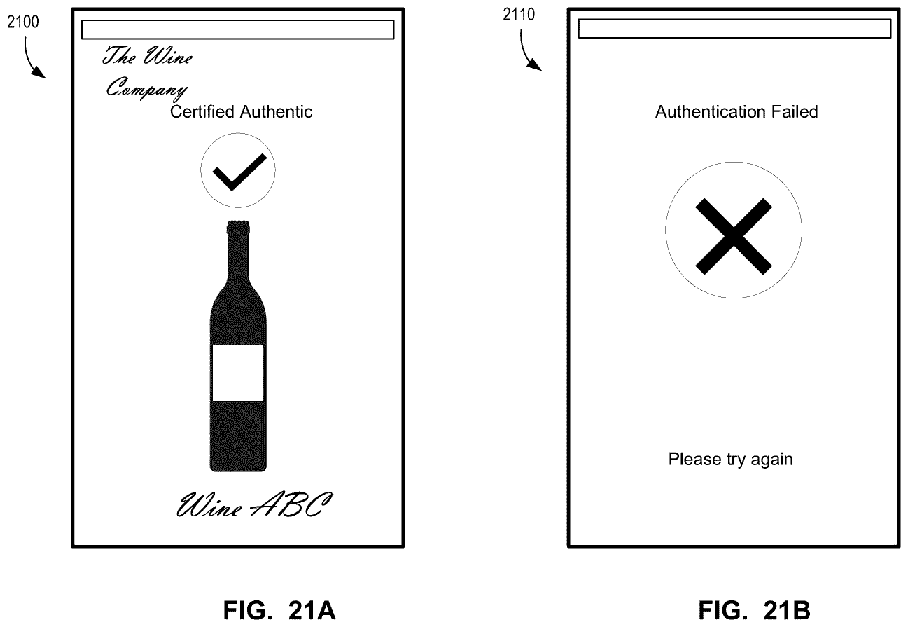

In some embodiments, the result of the comparison can be displayed on a GUI of a computing device. As shown in FIGS. 21A-21B, which shows screenshots 2100 and 2110 of an example GUI, if the product is determined to be authentic, a message can be displayed on the GUI certifying that the product is authentic (as shown in FIG. 21A). If the product is determined to be inauthentic, a message can be displayed on the GUI indicating that the authentication has failed (as shown in FIG. 21B).

In some embodiments, the product can be associated with a virtual object that can be displayed on a GUI of the user device 120. The virtual object can be a static object or can be an interactive, animated and/or shape-changing virtual object. The virtual object can be generated based on information about the product, for example, the serial number of the product and/or the batch identifier of the product. The virtual object can be dynamically generated (e.g., generated when an image of the product is captured with a camera of the user device 120). The virtual object can be a representation of the product. For example, based on the batch identifier and/or the serial number of the product, the tag management system 160 can determine physical characteristics (e.g., shape, color) of the product and generate a virtual object having the physical characteristics of the product. Alternatively, or in addition thereto, the virtual object can include a message (e.g., audio, video, text) about the product. For example, the message can include information about the product. As another example, the message can be a message by a brand ambassador promoting the product. The virtual object can be universally unique (i.e., each copy of a product can be associated with a unique virtual object) or can be specific to the product, the product type or the product brand.

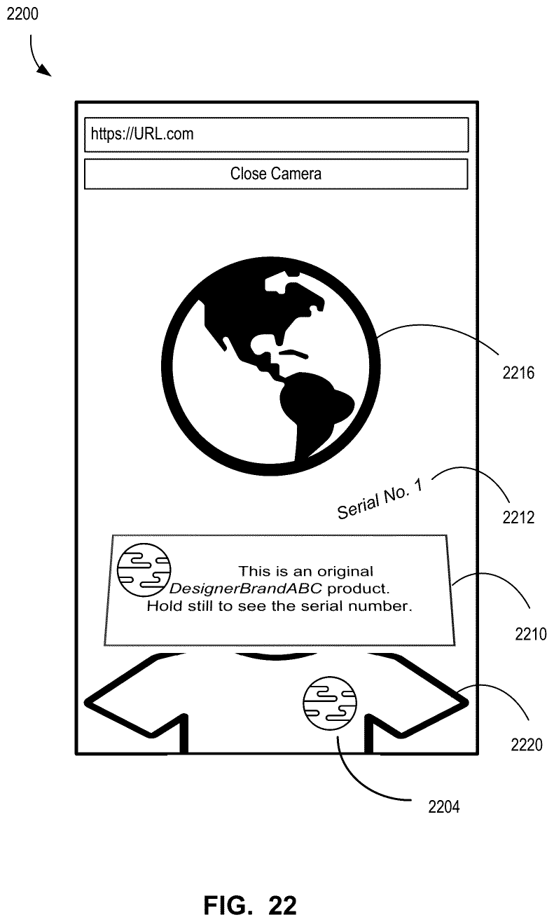

The virtual object can be displayed after the product is authenticated according to methods 900 or 920. For example, as shown in FIG. 22, the tag affixed to the product 2220 can be scanned. In the example of FIG. 22, the tag is embedded in the logo 2204. The product can then be authenticated. If the product is determined to be authentic, the virtual object can be displayed. In some embodiments, if the product is determined to be authentic, the user can be prompted to capture an image of or scan the product and/or a logo on the product. For example, the user can be prompted to capture an image of the product and/or logo or scan the product and/or logo using the camera of the user device 120 used to scan the tag and the virtual object can be displayed after the product is scanned/imaged. The prompt can be a prompt displayed on the GUI that when selected, automatically launches the camera of the user device 120 used to scan the tag.

As shown in FIG. 22, in some embodiments, the virtual object 2216 is displayed via augmented reality technology. As shown in FIG. 22, additional information about the product can be displayed. For example, the serial number 2212 and/or a message 2210 confirming the authenticity of the product can be displayed. The virtual object 2216, the serial number 2212 and/or the message 2210 can be displayed while the product 2220 and/or the logo 2204 is within the field of view of the camera of the user device 120.

In some embodiments, the virtual object is transferable, for example, via a marketplace.

Referring now to FIG. 12, there is shown a flowchart of a blockchain method 1200 of authenticating a product associated with a batch production in a manufacturing process. Reference is simultaneously made to FIG. 12B, which shows the method 1200 in a simplified block diagram form. Similar to method 1000, the product being authenticated can be a product to which a tag created using the method 300 is attached. Unlike method 1000 however, method 1200 can be performed when the authentication system 264 is not functional, temporarily unavailable or no longer in existence. When a central authentication server such as authentication system 264 cannot be accessed, the first and second decryption keys stored in the database can no longer be accessed and therefore the product cannot be authenticated by comparing the first decrypted information with data stored in a database, by comparing the first decrypted information and the second decrypted information or by comparing the second decrypted information with identification information contained in the address associated with the product. Method 1200 allows a product to be authenticated without the use of the authentication system 264.

Method 1200 can be performed by a computing device 1222 capable of accessing the blockchain system 150. Computing device 1222 can correspond to a user device 120.

At 1202, the computing device 1222 retrieves identification information for the product from an address associated with the tag affixed to the product being authenticated 1250. The identification information includes a first encrypted chain identifier.

In some embodiments, the identification information additionally includes a batch identifier for the batch production and a serial number for the tag.

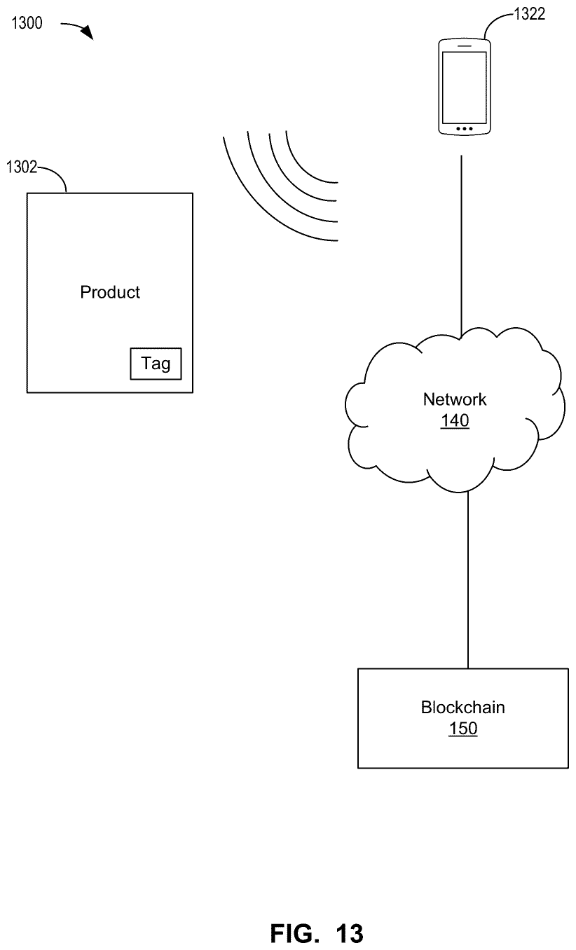

Referring briefly to FIG. 13, which shows a block diagram 1300 of the components used for performing the method 1300. As shown, the computing device 1322 can be used to scan the tag affixed to product 1302. As described, the tag can be a wireless readable tag and the computing 1322 can wirelessly scan the tag to retrieve an address of the tag.

Returning to FIG. 12, at 1204, the computing device 1222 identifies an address on the blockchain system 150 for the smart contract 858 used for authenticating the product. The smart contract corresponds to the smart contract generated at the time a first claim of ownership is received by the tag management 160, as described above.

In some embodiments, the computing device identifies the address of the smart contract using a token 1260, representative of the product, on the blockchain. As described above with reference to method 300, a token representative of the product can be generated upon ownership of the product being claimed by a user device 120. The token, stored in a wallet 720 associated with the owner of the product, can include the address of the smart contract, which can allow the computing device to access the smart contract. Accessing the smart contract via the token ensure that the correct, authentic smart contract is used.

At 1206, the computing device retrieves, from the genesis record 556 associated with the batch production stored on the blockchain system 150, a batch creation time. The genesis record can be accessed by the computing device via a pointer in the smart contract pointing to the genesis record.

Alternatively, or in addition thereto, the token representative of the product includes the blockchain address for the genesis record, which can allow the computing device to access information in the genesis record.

At 1208, the computing device transmits to the smart contract identified at 1204 a first decryption key fragment 1240, a product key and an offset value to decrypt the smart contract to obtain a second decryption key fragment to decrypt the first encrypted chain identifier obtained at 1202. The product key is a random integer unique to each product in a batch. The offset value is a unique value used for decrypting the smart contract. Each of the first decryption key fragment, the product key and the offset value can be obtained by the computing device at an earlier time, prior to 1208. For example, the first decryption key fragment, the product key and/or the offset value can be transmitted at the time or following a claim of ownership. That is, upon claiming ownership over a product, the computing device claiming ownership can receive, from the tag management system 160, the product key and/or the offset value. At a predetermined time following batch creation or when all products in a batch have been claimed, the first decryption key fragment can be transmitted to the user device. The first decryption key fragment, the product key and/or the offset value can be transmitted to the computing device using any means that allow the individual associated with the computing device to make a record of or retain the first decryption key fragment, the product key and/or the offset value. For example, each of these can be transmitted via email to an email address associated with the individual associated with the computing device, via a mobile device application and/or via text messaging. For example, upon claiming ownership over the product, the individual may be prompted to provide an email address so that the tag management system 160 can transmit the information to the individual. Each of the first decryption key fragment, the product key and the offset value can be unique to the product or unique within the batch production. In some embodiments, the computing device passes the address associated with the tag to the smart contract along with the first decryption key fragment, the product key and the offset value. In some embodiments, the computing device transmits the serial number of the product to the smart contract. The serial number transmitted can be a serial number retrieved from the token representative of the product.

In some embodiments, the token representative of the product includes the offset value. In such cases, the offset value may not be transmitted to the computing device at the time of the claim of ownership. Retrieving the offset value from the token can help prevent unauthorized users (e.g., users who do not own the product) from obtaining the second decryption key fragment.

In some embodiments, when the user device 120 associated with the individual to which the product belongs claims ownership of the product, as described above, the tag management system 160 transmits to the user device 120, the first decryption key fragment, the product key and/or the offset value. As described above, the first decryption key fragment can be a fragment of a decryption key that is fragmented when a first claim of ownership is received by the tag management system 160.

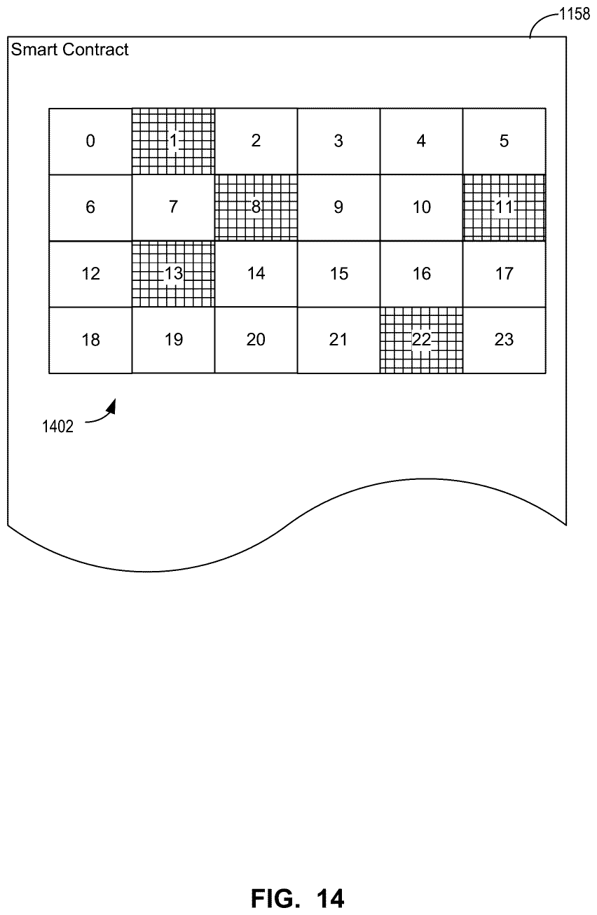

In some embodiments, the smart contract includes an array which contains decryption key fragments and obtaining the second decryption key fragment involves locating the second decryption key fragment in the array. Multiple decryption key fragments can be placed in the array and the decryption key fragments can be randomly placed within the array. Referring now briefly to FIG. 14, there is shown an array 1402 within the smart contract 1158. As shown, array indices 1, 8, 11, 13 and 22 contain decryption key fragments that can be used to decrypt the smart contract. The location of the decryption key fragments can be randomized.

The rest of the indices can be associated with artificial decryption key fragments, for example, randomly generated key fragments that cannot be used to decrypt the smart contract. Interspersing artificial decryption key fragments in the array 1402 can reduce the likelihood of genuine decryption key fragments being accessed without authorization and therefore reduce the likelihood of the smart contract being decrypted by malicious users. To identify indices containing a decryption key fragment, in some embodiments, a combined sequence number is determined and the combined sequence number is used to determine a location within the array containing a decryption key fragment. In such embodiments, the combined sequence number is determined based on the offset value and the product key. For example, as described at 1208, the product key and the offset value can be transmitted to the smart contract 1158. By transmitting the product key and the offset value to the smart contract 1158, the smart contract can calculate a combined sequence number. In some embodiments, the combined sequence number is an integer value that can be used to identify the index of an array in the smart contract 1158 containing a genuine decryption key fragment. As each owner is associated with a separate first decryption key fragment and offset value, different combined sequence numbers can be obtained, though each second decryption key fragment can be obtained by more than one owner.

The combined sequence number is defined by the following equation:

$$Combined Sequence number = Offset value - Product key \qquad ( 1 )$$

In some embodiments, the smart contract maintains a cartesian plane mapping that pairs values to indices of the array 1402 containing genuine second decryption key fragments. In some embodiments, the mapping is a Cantor function, according to the following equation:

$$cantorFunction ( s , k ) = \frac{( s + k ) ( s + k + 1 )}{2} + k \qquad ( 2 )$$

where s is a serial number in an array S representing the serial number of the tags and k represents an index of the array 1402, and the combined sequence number is the result of the Cantor function, according to the following equation:

$$Combined Sequence number = cantorFunction ( s , k ) \qquad ( 3 )$$

To retrieve the second decryption key fragment, the s and k values can be obtained according to the following equations:

$$n = ( - 1 + ( - 1 + \sqrt{8 C + 1} ) / 2 \qquad ( 4 )$$

$$s = C - \frac{1}{2} ( n + 1 ) n \qquad ( 5 )$$

$$k = n - 1 \qquad ( 6 )$$

The s and k values are then used to determine the location in the array 1402 of a second decryption key fragment. C is the combined sequence number obtained using equation 1.

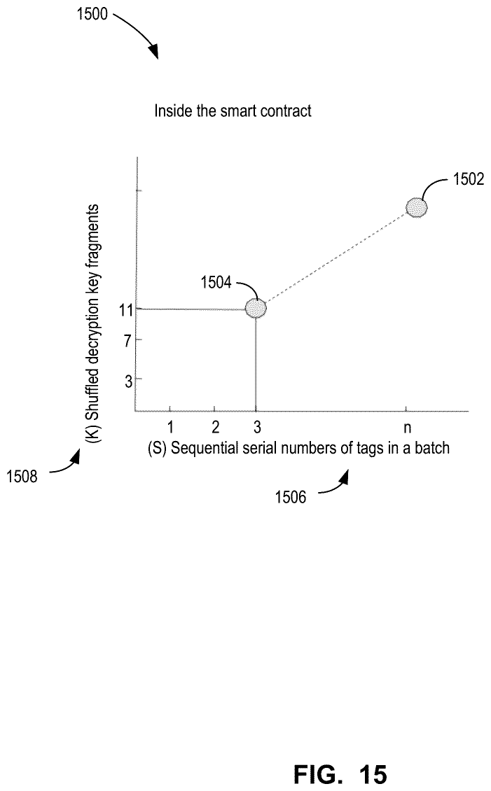

Reference is now made to FIG. 15, which shows a visual representation of the offset value 1502, the combined sequence number 1504 and the s (x-axis) 1506 and k (y-axis) 1508 values, using plot 1500. As shown, the x-axis corresponds to the serial numbers of the tags in the batch production and the y-axis corresponds to indices in the array of decryption key fragment 1402. As described, to identify indices containing a decryption key fragment, the processor can determine a combined sequence number. As shown in plot 1500, combined sequence number 1504 is the number associated with offset value 1502 and a product key associated with the tag. In the illustrated example, the combined sequence number 1504 is the result of the Cantor function for a given s and k value. As described, the offset value and the product key can be obtained from the owner of the product to which the tag is affixed. As described, the offset value can be retrieved from a token associated with the tag. As shown in plot 1500, the s and k value for the tag correspond to the (x,y) coordinates of the combined sequence number. In the example shown in plot 1500, the s and k values are (3, 11). In other words, the decryption key fragment with index 11 in the array 1402 is associated with the tag having serial number 3. The decryption key fragment can then be retrieved from index 11 in the array 1402. This decryption key fragment can be combined with the first decryption key provided by a user device associated with the owner of the product to decrypt the first chain identifier and obtain the batch creation time.

In some embodiments, the smart contract further includes a bit array that is associated with the number of products in the batch production and each bit of the bit array identifies a serial number for a product in the batch production. In such embodiments, when the serial number of the product is obtained from the tag, the computing device determines if the serial number for the product is present in the bit array and if the serial number is not present in the bit array, the product is determined to be inauthentic. For example, each bit of the bit array can be initialized to zero and each time ownership over a product in the batch production is claimed, the bit in the bit array corresponding to the serial number associated with the tag affixed to the product can be updated (e.g., from a 0 to a 1). When the smart contract is verified, if the bit corresponding to the serial number is in its original state (i.e., is a 0), the computing device determines that the product is inauthentic. Further, if the bit array does not contain a bit corresponding to the serial number of the product, the product is determined to be inauthentic since the serial number would correspond to a product that does not exist within the batch. The bit array can additionally safeguard against duplicate serial numbers. For example, if the bit corresponding to the serial number has already been updated, any further attempts to update the bit will be unsuccessful.

In some embodiments, the bit array of the smart contract is evaluated prior to decrypting the smart contract so that only valid tags are assessed to determine their authenticity. The use of a bit array can prevent inauthentic products from being added to a batch since the bit array only contains bits representing the original number of products in the batch.

The combination of the use of the bit array and of the array 1402 interspersing second decryption key fragments with artificial decryption key fragments can prevent inauthentic products from being authenticated, since the location of the second decryption key fragments cannot be obtained without the unique offset value.

At 1210, the computing device decrypts the first chain identifier using the first decryption fragment and the second decryption key fragment obtained at 1208.

At 1212, the computing device determines the authenticity of the product based on a comparison of a batch creation time comprised in the first chain identifier decrypted at 1210 and the batch creation time retrieved at 1206. If the first chain identifier and the batch creation time match, that is, if the batch creation time of the chain identifier decrypted from the address associated with the product and the batch creation time in the genesis record match, at 1214, the computing device determines the product to be authentic. If the batch creation time of the first chain identifier and the batch creation time in the genesis record do not match, at 1216, the computing device determines the product to be inauthentic. The result of the comparison can be displayed as described with reference to FIGS. 21A-21B. In some embodiments, a virtual object can be generated, as described with reference to FIG. 22.

In some embodiments, the computing device compares the serial number comprised in the first chain identifier and the serial number determined by the smart contract (i.e., the s number) to determine the authenticity of the product.

Reference is now briefly made to FIGS. 12C-12D, which show portions of the smart contract 858 and of the genesis record 556. The product authenticated in FIG. 12C is determined using method 1200 to be authentic, since the batch creation time decrypted by the smart contract 858 matches the batch creation time recorded in the genesis record 556. By contrast, the product authenticated in FIG. 12D is determined using method 1200 to be inauthentic, since the batch creation time decrypted by the smart contract 858 does not match the batch creation time recorded in the genesis record 556.

Reference is now briefly made to FIGS. 12E-12F, which show a bit array of the smart contract 858 and portions of tags 404-8 and 404-9. The product associated with tag 404-8 is determined to be authentic, since the bit in the bit array of smart contract 858 corresponding to the serial number (“4”) decrypted has been updated (i.e., the bit associated with serial number 4 is associated with a value of “1”). By contrast, the product associated with tag 404-9 is determined to be inauthentic, since the bit in the bit array of smart contract 858 corresponding to the serial number (“3”) decrypted has not been updated (i.e., the bit associated with serial number 4 is associated with a value of “0”).

In some embodiments, the computing device compares the address of the blockchain wallet from which the token is originally generated and the address of the blockchain wallet from which the genesis record is generated.

In some embodiments, upon successful authentication of a product, a transaction (e.g., a proof of ownership transaction) is recorded in the blockchain system 150. The transaction can record the serial number of the product validated, the offset value used and the batch creation time as recorded in the genesis record 356. The transaction can additionally record blockchain wallet information, including information about the wallet generating the genesis record. Referring back to FIG. 8, one or more blocks 855 can correspond to a proof of ownership transaction.

In other embodiments, one or more of the following items may be included.

Item 1. A method for generating tag information for a plurality of tags affixable to a plurality of products, the plurality of products being associated with a batch production in a manufacturing process, the batch production yielding a predetermined number of products corresponding to a same product type, the method comprising: receiving, at a tag creation system, from a manufacturing system associated with a manufacturer operating the batch production, information related to the batch production; generating, by a processor of the tag creation system, a first cryptographic key pair and a second cryptographic key pair associated with the predetermined number of products corresponding to the batch production; generating, by the processor of the tag creation system, for each of the plurality of tags, a corresponding record, each record comprising at least a portion of the information related to the batch production; and transmitting to an encoding system, an encryption key of the first cryptographic key pair, an encryption key of the second cryptographic key pair and instructions for encoding each record on the corresponding tag, wherein the instructions comprise: instructions for encrypting a unique first encryptable information in a first portion of a corresponding record using the encryption key of the first cryptographic key pair; and instructions for encrypting a unique second encryptable information in a second portion of the corresponding record using the encryption key of the second cryptographic key pair.

Item 2. The method of item 1, wherein the information related to the batch production comprises one or more of a batch identifier corresponding to the batch production in the manufacturing process, a product identifier corresponding to the predetermined number of products in the batch production, a batch creation time corresponding to a time of completion of the batch production and a product count corresponding to the predetermined number of products yielded in the batch production.

Item 3. The method of items 1 or 2, wherein, for each record, the first encryptable information comprises a tag identifier of the corresponding tag.

Item 4. The method of item 3, wherein the tag identifier is a universally unique identifier (UUID).

Item 5. The method of any one of items 1 to 4, further comprising storing the information related to the batch production in a database.

Item 6. The method any one of items 3 to 5, wherein, for each record, the second encryptable information comprises a chain identifier, wherein the chain identifier comprises a batch creation time corresponding to a time of completion of the batch production, the tag identifier identifying the corresponding tag and a serial number for the corresponding tag.

Item 7. The method of any one of items 1 to 6, further comprising: generating a genesis record for the batch production comprising the information related to the batch production; and storing the genesis record on a block in a blockchain.

Item 8. The method of item 7, wherein generating the genesis record comprises initiating a transaction between a first blockchain wallet and a second blockchain wallet, the first blockchain wallet and the second blockchain wallet associated with the tag creation system.

Item 9. The method of any one of items 1 to 8, further comprising: upon completion of encryption of the second encryptable information on the plurality of records corresponding to the plurality of tags, discarding the encryption key of the second cryptographic key pair.

Item 10. The method of any one of items 1 to 9, wherein each of the plurality of tags is one of an NFC tag or an RFID tag.

Item 11. The method of any one of items 7 to 10, further comprising: receiving, from a user device, a claim of ownership signal for a product of the plurality of products; and in response to receiving the claim of ownership signal, generating a token representative of the product in the blockchain.

Item 12. The method of item 11, wherein the token includes a pointer to one or more of the genesis record and a smart contract associated with the batch production.

Item 13. The method of item 12, further comprising: generating, in response to a first claim of ownership corresponding to the batch production, the smart contract associated with the batch production.

Item 14. The method of any one of items 11 to 13, further comprising: fragmenting a decryption key of the second cryptographic key pair into a plurality of fragments; and in response to receiving the claim of ownership, transmitting, to the user device, one fragment of the plurality of fragments.

Item 15. The method of item 14, wherein the plurality of fragments corresponds to the predetermined number of products.

Item 16. The method of any one of items 11 to 15, further comprising: receiving, from a first consumer associated with a first user device, an indication of a transfer of ownership of the token to a second consumer associated with a second user device; and recording the transfer of ownership in a database.

Item 17. A system for generating tag information for a plurality of tags affixable to a plurality of products, the plurality of products being associated with a batch production in a manufacturing processor, the batch production yielding a predetermined number of products corresponding to a same product type, the system comprising: a manufacturing system associated with a manufacturer operating the batch production, the manufacturing system comprising a processor configured to generate information related to the batch production and transmit the information related to the batch production; a tag creation system comprising at least one processor configured to: receive, from the manufacturing system, information related to the batch production; generate a first cryptographic key pair and a second cryptographic key pair associated with the predetermined number of products corresponding to the batch production; generate, for each of the plurality of tags, a corresponding record, each record comprising at least a portion of the information related to the batch production; and transmit an encryption key of the first cryptographic key pair, an encryption key of the second cryptographic key pair and instructions for encoding each record on the corresponding tag, wherein the instructions comprise: instructions for encrypting a unique first encryptable information in a first portion of a corresponding record using the encryption key of the first cryptographic key pair; and instructions for encrypting a unique second encryptable information in a second portion of the corresponding record using the encryption key of the second cryptographic key pair; and an encoding system configured to encode each of the plurality of tags according to the instructions received from the tag creation system.

Item 18. The system of item 17, wherein the information related to the batch production comprises one or more of a batch identifier corresponding to the batch production in the manufacturing process, a product identifier corresponding to the predetermined number of products in the batch production, a batch creation time corresponding to a time of completion of the batch production and a product count corresponding to the predetermined number of products yielded in the batch production.

Item 19. The system of items 17 or 18, wherein, for each record, the first encryptable information comprises a tag identifier of the corresponding tag.

Item 20. The system of item 19, wherein the tag identifier is a universally unique identifier (UUID).

Item 21. The system of any one of items 17 to 20, wherein the tag creation system processor is further configured to store the information related to the batch production in a database.

Item 22. The system of any one of items 19 to 21, wherein, for each record, the second encryptable information comprises a chain identifier, wherein the chain identifier comprises a batch creation time corresponding to a time of completion of the batch production, the tag identifier identifying the corresponding tag and a serial number for the corresponding tag.

Item 23. The system of any one of items 17 to 22, wherein the tag creation system processor is further configured to: generate a genesis record for the batch production comprising the information related to the batch production; and store the genesis record on a block in a blockchain.

Item 24. The system of item 23, wherein generating the genesis record comprises initiating a transaction between a first blockchain wallet and a second blockchain wallet, the first blockchain wallet and the second blockchain wallet associated with the tag creation system.

Item 25. The system of any one of items 17 to 24, wherein the tag creation system processor is configured to: upon completion of encryption of the second encryptable information on the plurality of records corresponding to the plurality of tags, discard the encryption key of the second cryptographic key pair.

Item 26. The system of any one of items 17 to 25 wherein each of the plurality of tags is one of an NFC tag or an RFID tag.

Item 27. The system of any one of items 33 to 26, wherein the tag creation system processor is configured to: receive from a user device, a claim of ownership signal for a product of the plurality of products; and in response to receiving the claim of ownership signal, generate a token representative of the product in the blockchain.

Item 28. The system of item 27, wherein the token includes a pointer to one or more of the genesis record and a smart contract associated with the batch production.

Item 29. The system of item 28, wherein the tag creation system processor is configured to generate, in response to a first claim of ownership corresponding to the batch production, the smart contract associated with the batch production.

Item 30. The system of any one of items 27 to 29, wherein the tag creation system processor is configured to: fragment a decryption key of the second cryptographic key pair into a plurality of fragments; and in response to receiving the claim of ownership, transmit, to the user device, one fragment of the plurality of fragments.

Item 31. The system of item 30, wherein the plurality of fragments corresponds to the predetermined number of products.

Item 32. The system of any one of items 27 to 31, wherein the tag creation system processor is further configured to: receive, from a first consumer associated with a first user device, an indication of a transfer of ownership of the token to a second consumer associated with a second user device; and record the transfer of ownership in a database.

Item 33. A method for authenticating, by an authentication server, one product of a plurality of products associated with a batch production in a manufacturing process, the batch production yielding a predetermined number of products corresponding to a same product type, each product having a corresponding tag affixed thereto, the method comprising: upon scanning a tag affixed to the product, receiving, from a computing device, an address associated with the tag, the address comprising identification information for the product; decrypting a first encrypted portion of the address using a first decryption key stored at the authentication server to obtain a first decrypted information; decrypting, a second encryption portion of the address using a second decryption key stored at the authentication server to obtain a second decrypted information; comparing at least a portion of the first decrypted information and the second decrypted information; and determining an authenticity of the product based on the comparison.

Item 34. The method of item 33, wherein the identification information for the product comprises one or more of a product identifier corresponding to the predetermined number of products in the batch production, a batch identifier corresponding to the batch production in the manufacturing process and a serial number corresponding to the tag affixed to the product.

Item 35. The method of items 33 or 34, wherein the first decrypted information comprises a tag identifier identifying the tag affixed to the product and a tap count corresponding to scan data of the tag.

Item 36. The method of any one of items 33 to 35, wherein the second decrypted information comprises a chain identifier, wherein the chain identifier comprises the tag identifier identifying the corresponding tag and a serial number for the corresponding tag.

Item 37. The method of item 36, wherein comparing at least a portion of the first decrypted information and the second decrypted information comprises comparing the tag identifier of the first decrypted information and the tag identifier of the second decrypted information.

Item 38. The method of items 36 or 37, further comprising comparing the serial number of the second decrypted information and a serial number comprised in the identification information for the product and determining the authenticity of the product based on the comparison.

Item 39. The method of any one of items 33 to 38, further comprising retrieving the second decryption key based on one or more of the product identifier and the batch identifier.

Item 40. The method any one of items 33 to 39 wherein the first decrypted information comprises a tap count and wherein the method further comprises: comparing the tap count and a previous tap count stored in a database; determining the authenticity of the product based on the tap count comparison; and in response to determining that the product is authentic, storing the tap count in the database.

Item 41. The method of any one of items 33 to 40, wherein the address is a uniform resource locator (URL).

Item 42. The method of any one of items 33 to 41, further comprising: generating a virtual object associated with the product; in response to determining the product is authentic, displaying an augmented reality representation of the virtual object on a graphical user interface.

Item 43. The method of item 42, wherein the virtual object is generated based on the identification information for the product.

Item 44. The method of items 42 or 43, further comprising: in response to determining the product is authentic, requesting an image of the product; and in response to receiving the image of the product, displaying the augmented reality representation of the virtual object on the graphical user interface.

Item 45. A system for authenticating one product of a plurality of products associated with a batch production in a manufacturing process, the batch production yielding a predetermined number of products corresponding to a same product type, each product having a corresponding tag affixed thereto, the system comprising: a computing device configured to: upon scanning the tag affixed to the product, determine an address associated with the tag, the address comprising identification information for the product; and transmit the address to an authentication server; a database storing a first decryption key and a second decryption key; and the authentication server in communication with the computing device and the database, the authentication server comprising at least one processor configured to: decrypt a first encrypted portion of the address using the first decryption key to obtain a first decrypted information; decrypt, a second encryption portion of the address using the second decryption key to obtain a second decrypted information; compare at least a portion of the first decrypted information and the second decrypted information; and determine an authenticity of the product based on the comparison.

Item 46. The system of item 45, wherein the identification information for the product comprises one or more of a product identifier corresponding to the predetermined number of products in the batch production, a batch identifier corresponding to the batch production in the manufacturing process and a serial number corresponding to the tag affixed to the product.

Item 47. The system of items 45 or 46, wherein the first decrypted information comprises a tag identifier identifying the tag affixed to the product and a tap count corresponding to scan data of the tag.

Item 48. The system of items 45 to 47, wherein the second decrypted information comprises a chain identifier, wherein the chain identifier comprises the tag identifier identifying the corresponding tag and a serial number for the corresponding tag.

Item 49. The system of item 48, wherein comparing at least a portion of the first decrypted information and the second decrypted information comprises compare the tag identifier of the first decrypted information and the tag identifier of the second decrypted information.

Item 50. The system of item 48 or 49, wherein the at least one processor is configured to: compare the serial number of the second decrypted information and the serial number comprised in the identification information for the product; and determine the authenticity of the product based on the comparison.

Item 51. The system of any one of items 45 to 50, wherein the at least one processor is configured to retrieve the second decryption key based on one or more of the product identifier and the batch identifier.

Item 52. The system of any one of items 45 to 51 wherein the first decrypted information comprises a tap count and wherein the at least one processor is further configured to: compare the tap count and a previous tap count stored in a database; determine the authenticity of the product based on the tap count comparison; and in response to determining that the product is authentic, store the tap count in the database.

Item 53. The system of any one of items 45 to 52 wherein the address is a uniform resource locator (URL).

Item 54. The system of any one of items 45 to 53, wherein: the at least one processor of the authentication server is configured to: generate a virtual object associated with the product; and in response to the authentication server determining the product is authentic, the computing device is configured to display an augmented reality representation of the virtual object on a graphical user interface of the computing device.

Item 55. The system of item 54, wherein the virtual object is generated based on the identification information for the product.

Item 56. The system of item 54 or 55, wherein the computing device is configured to: request an image of the product; and in response to receiving the image of the product, display the augmented reality representation of the virtual object on the graphical user interface.

Item 57. A blockchain based method for authenticating, by a computing device, one product of a plurality of products associated with a batch production in a manufacturing process, the batch production yielding a predetermined number of products corresponding to a same product type, each product having a corresponding tag affixed thereto, the method comprising: upon scanning the tag affixed to the product, retrieving identification information for the product from an address associated with the tag, the identification information comprising an encrypted first chain identifier; identifying an address on a blockchain for a smart contract for authenticating the product; retrieving, from a genesis record associated with the batch production, stored on the blockchain, a batch creation time for the product; transmitting to the smart contract, a first decryption key fragment, a product key and an offset value to decrypt the smart contract to obtain a second decryption key fragment for the encrypted first chain identifier; decrypting the first chain identifier using the first decryption key fragment and the second decryption key fragment; and determining an authenticity of the product based on a comparison of a batch creation time included in the first decrypted chain identifier and the batch creation time included in the genesis record.

Item 58. The method of item 57, wherein the first decryption key fragment is previously received by the computing device at a time of a claim of ownership.

Item 59. The method of item 57 or 58, wherein the product key is previously received by the computing device at a time of a claim of ownership.

Item 60. The method of any one of items 57 to 59, wherein the decrypted first chain identifier comprises a serial number of the product.

Item 61. The method of item 60, wherein the smart contract comprises a bit array associated with the number of products in the batch production, each bit of the bit array identifying a serial number for a product in the batch production and wherein the method further comprises: determining if the serial number of the product of the decrypted first chain identifier is present in the bit array; and in response to determining that the serial number of the product of the first chain identifier is not present in the bit array, determining that the product is inauthentic.

Item 62. The method of any one of items 57 to 61, further comprising determining the address for the smart contract from a token on the blockchain, the token associated with a consumer associated with the computing device.

Item 63. The method of item 62 wherein the genesis record is stored on the blockchain and wherein the method further comprises determining an address for the genesis record from the token.

Item 64. The method of items 62 or 63, wherein the token comprises the offset value.

Item 65. The method of any one of items 57 to 64, wherein the smart contract comprises an array and wherein obtaining the second decryption key fragment comprises locating the second decryption key fragment in the array.

Item 66. The method of item 65, wherein obtaining the second key fragment comprises determining a combined sequence number based on the offset value and the product key and determining a location in the array of the second key fragment based on the combined sequence number.

Item 67. The method of item 66, further comprising: determining a serial number for the product based on the combined sequence number; and comparing the determined serial number and the serial number of the decrypted first chain identifier to determine the authenticity of the product.

Item 68. The method of any one of items 57 to 67, wherein the identification information further comprises a batch identifier and a serial number for the tag.

Item 69. The method of any one of items 57 to 68, further comprising: generating a virtual object associated with the product; in response to determining the product is authentic, displaying an augmented reality representation of the virtual object on a graphical user interface.

Item 70. The method of item 68, wherein the virtual object is generated based on the identification information for the product.

Item 71. The method of items 69 or 70, further comprising: in response to determining the product is authentic, requesting an image of the product; and in response to receiving the image of the product, displaying the augmented reality representation of the virtual object on the graphical user interface.

Item 72. A blockchain based system for authenticating one product of a plurality of products associated with a batch production in a manufacturing process, the batch production yielding a predetermined number of products corresponding to a same product type, each product having a corresponding tag affixed thereto, the system comprising: a blockchain accessible by a computing device, the blockchain storing a genesis record and a smart contract; and the computing device comprising at least one processor configured to: retrieve identification information for the product, from an address associated with a tag affixed to the product, the identification information comprising an encrypted first chain identifier; identify an address on a blockchain, for a smart contract, for authenticating the product; retrieve from a genesis record associated with a batch, a batch creation time for the product; transmit to the smart contract, a first decryption key fragment and a sequence number for the product to decrypt the smart contract to obtain a second decryption key fragment for the encrypted first chain identifier; decrypt the encrypted first chain identifier using the first decryption key fragment and the second decryption key fragment; and determine an authenticity of the product based on a comparison of a batch creation time included in the decrypted first chain identifier and the batch creation time included in the genesis record.

Item 73. The system of item 72, wherein the first decryption key fragment is previously received by the computing device at a time of a claim of ownership.

Item 74. The system of items 72 or 73, wherein the product key is previously received by the computing device at a time of a claim of ownership.

Item 75. The system of item 74, wherein the decrypted first chain identifier comprises a serial number for the product.

Item 76. The system of item 75, wherein the smart contract comprises a bit array associated with the number of products in the batch production, each bit of the bit array identifying a serial number for a product in the batch production and wherein the at least one processor is configured to: determine if the serial number of the product of the decrypted first chain identifier is present in the bit array; and in response to determining that the serial number of the product of the decrypted first chain identifier is not present in the bit array, determine that the product is inauthentic.

Item 77. The system of any one of items 72 to 76, wherein the at least one processor is further configured to determine the address for the smart contract from a token on the blockchain, the token associated with a consumer associated with the computing device.

Item 78. The system of item 77, wherein the genesis record is stored on the blockchain and wherein the at least one processor is configured to determine an address for the genesis record from the token.

Item 79. The system of items 77 or 78, wherein the token comprises the offset value.

Item 80. The system of any one of items 72 to 79, wherein the smart contract comprises an array and wherein the at least one processor is configured to locate the second decryption key fragment in the array.

Item 81. The system of item 80, wherein obtaining the second key fragment comprises determining a combined sequence number based on the offset value and the product key and wherein the at least one processor is configured to determine a location in the array of the second key fragment based on the combined sequence number.

Item 82. The system of item 81, wherein the at least one processor is configured to: determine a serial number for the product based on the combined sequence number; compare the determined serial number and the serial number of the decrypted first chain identifier to determine the authenticity of the product.

Item 83. The system of any one of items 72 to 82, wherein the identification information further comprises a batch identifier and a serial number for the tag.

Item 84. The system of any one of items 72 to 83, wherein the at least one processor is configured to: generate a virtual object associated with the product; and in response to the authentication server determining the product is authentic, display an augmented reality representation of the virtual object on a graphical user interface of the computing device.

Item 85. The system of item 84, wherein the virtual object is generated based on the identification information for the product.

Item 86. The system of items 84 or 85, wherein the at least one processor is configured to: request an image of the product; and in response to receiving the image of the product, display the augmented reality representation of the virtual object on the graphical user interface.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A blockchain based method for authenticating, by a computing device, one product of a plurality of products associated with a batch production in a manufacturing process, the batch production yielding a predetermined number of products corresponding to a same product type, each product having a corresponding tag affixed thereto, the method comprising:
upon scanning the tag affixed to the product, retrieving identification information for the product from an address associated with the tag, the identification information comprising an encrypted first chain identifier;
identifying an address on a blockchain for a smart contract for authenticating the product;
retrieving, from a genesis record associated with the batch production, stored on the blockchain, a batch creation time for the product;
transmitting to the smart contract, a first decryption key fragment, a product key and an offset value to decrypt the smart contract to obtain a second decryption key fragment for the encrypted first chain identifier;
decrypting the encrypted first chain identifier using the first decryption key fragment and the second decryption key fragment; and
determining an authenticity of the product based on a comparison of a batch creation time included in the decrypted first chain identifier and the batch creation time included in the genesis record.

2. The method of claim 1, wherein the first chain identifier comprises a serial number of the product.

3. The method of claim 2, wherein the smart contract comprises a bit array associated with the number of products in the batch production, each bit of the bit array identifying the serial number for the product in the batch production and wherein the method further comprises:
determining if the serial number of the product of the decrypted first chain identifier is present in the bit array; and
in response to determining that the serial number of the product of the first chain identifier is not present in the bit array, determining that the product is inauthentic.

4. The method of claim 1 wherein the genesis record is stored on the blockchain and wherein the method further comprises determining an address for the genesis record from a token associated with a consumer associated with the computing device.

5. The method of claim 4, wherein the token comprises an offset value.

6. The method of claim 1, wherein the smart contract comprises an array and wherein obtaining the second decryption key fragment comprises locating the second decryption key fragment in the array.

7. The method of claim 6, wherein obtaining the second key fragment comprises determining a combined sequence number based on the offset value and the product key and determining a location in the array of the second key fragment based on the combined sequence number.

8. The method of claim 7, further comprising:
determining a serial number for the product based on the combined sequence number; and
comparing the determined serial number and a serial number comprised in the decrypted first chain identifier to determine the authenticity of the product.

9. A blockchain based system for authenticating one product of a plurality of products associated with a batch production in a manufacturing process, the batch production yielding a predetermined number of products corresponding to a same product type, each product having a corresponding tag affixed thereto, the system comprising:
a blockchain accessible by a computing device, the blockchain storing a genesis record and a smart contract; and
the computing device comprising at least one processor configured to:
retrieve identification information for the product, from an address associated with a tag affixed to the product, the identification information comprising an encrypted first chain identifier;
identify an address on a blockchain, for a smart contract, for authenticating the product;
retrieve from a genesis record associated with a batch, a batch creation time for the product;
transmit to the smart contract, a first decryption key fragment and a sequence number for the product to decrypt the smart contract to obtain a second decryption key fragment for the encrypted first chain identifier;
decrypt the encrypted first chain identifier using the first decryption key fragment and the second decryption key fragment; and
determine an authenticity of the product based on a comparison of a batch creation time included in the decrypted first chain identifier and the batch creation time included in the genesis record.

10. The system of claim 9, wherein the decrypted first chain identifier comprises a serial number for the product.

11. The system of claim 10, wherein the smart contract comprises a bit array associated with the number of products in the batch production, each bit of the bit array identifying a serial number for a product in the batch production and wherein the at least one processor is configured to:
determine if the serial number of the product of the decrypted first chain identifier is present in the bit array; and
in response to determining that the serial number of the product of the first chain identifier is not present in the bit array, determine that the product is inauthentic.

12. The system of claim 9, wherein the genesis record is stored on the blockchain and wherein the at least one processor is configured to determine an address for the genesis record from the token.

13. The system of claim 12, wherein the token comprises the offset value.

14. The system of claim 9, wherein the smart contract comprises an array and wherein the at least one processor is configured to locate the second decryption key fragment in the array.

15. The system of claim 14, wherein obtaining the second key fragment comprises determining a combined sequence number based on the offset value and the product key and wherein the at least one processor is configured to determine a location in the array of the second key fragment based on the combined sequence number.

16. The system of claim 15, wherein the at least one processor is configured to:
determine a serial number for the product based on the combined sequence number;
compare the determined serial number and the serial number of the decrypted first chain identifier to determine the authenticity of the product.

17. A method for authenticating, by an authentication server, one product of a plurality of products associated with a batch production in a manufacturing process, the batch production yielding a predetermined number of products corresponding to a same product type, each product having a corresponding tag affixed thereto, the method comprising:
upon scanning a tag affixed to the product, receiving, from a computing device, an address associated with the tag, the address comprising identification information for the product;
decrypting a first encrypted portion of the address using a first decryption key stored at the authentication server to obtain a first decrypted information;
decrypting, a second encryption portion of the address using a second decryption key stored at the authentication server to obtain a second decrypted information;
comparing at least a portion of the first decrypted information and the second decrypted information; and
determining an authenticity of the product based on the comparison.

18. The method of claim 17, wherein the identification information for the product comprises one or more of a product identifier corresponding to the predetermined number of products in the batch production, a batch identifier corresponding to the batch production in the manufacturing process and a serial number corresponding to the tag affixed to the product.

19. The method of claim 17, wherein the second decrypted information comprises a chain identifier, wherein the chain identifier comprises the tag identifier identifying the corresponding tag and a serial number for the corresponding tag.

20. The method of claim 19, wherein comparing at least a portion of the first decrypted information and the second decrypted information comprises comparing the tag identifier of the first decrypted information and the tag identifier of the second decrypted information.
